(19) United States
(12) Patent Application Publication
(10) Pub. No.: US 2024/0322888 A1
(43) Pub. Date: Sep. 26, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Wenhong CHEN, Dongguan (CN); Yingpei HUANG, Dongguan (CN); Zhi ZHANG, Dongguan (CN)

(73) Assignee: GUANGDONG OPPO MOBILE TELECOMMUNICATIONS CORP., LTD., Dongguan (CN)

(21) Appl. No.: 18/646,501

(22) Filed: Apr. 25, 2024

Related U.S. Application Data
(63) Continuation of application No. PCT/CN2021/127157, filed on Oct. 28, 2021.

(51) Int. Cl. H04B 7/06; H04L 27/26; H04L 27/34

(52) U.S. Cl. CPC H04B 7/0639; H04B 7/0634; H04L 27/2636; H04L 27/34

(57) ABSTRACT

Provided in the present application are a wireless communication method, a terminal device, and a network device. A codebook supporting uplink transmission based on a 3-antenna port is designed, the antenna gain of 3-antenna port transmission can be fully utilized, and the spectral efficiency and the peak rate can be improved. The wireless communication method includes: receiving, by a terminal device, a TPMI and a TRI transmitted by a network device; determining, by the terminal device and based on the TPMI, a precoding matrix from a codebook which corresponds to the TRI, wherein each codeword of the codebook includes three rows; performing, by the terminal device, a precoding process of data by using the precoding matrix; and transmitting, by the terminal device, the precoded data.

### CROSS REFERENCE TO RELATED APPLICATION

The present disclosure is a continuation application of International (PCT) Patent Application No. PCT/CN2021/127157 filed on Oct. 28, 2021, the content of which is incorporated herein by reference in its entirety.

### TECHNICAL FIELD

Embodiments of the present disclosure relate to the field of communication technology, and in particularly to a wireless communication method, a terminal device, and a network device.

### BACKGROUND

Nowadays, in the codebook-based precoding approach, an uplink transmission supports codebooks of 2 antenna ports and 4 antenna ports. The network device indicates the transmit precoding matrix indicator (TPMI) via the downlink control information (DCI). The terminal device determines the precoding matrix corresponding to the TPMI from a codebook according to the TPMI. However, for some special terminals, other number of antenna ports (e.g., 3 antenna ports) may be supported. In this case, how to design the codebook is an urgent issue to be solved.

### SUMMARY OF THE DISCLOSURE

A wireless communication method, a terminal device and a network device are provided according to embodiments of the present disclosure. A codebook supporting the uplink transmission based on 3 antenna ports is designed. In this way, the antenna gains of the 3-antenna-port transmission may be fully utilized. The spectral efficiency and the peak rate may be increased.

According to a first aspect, a wireless communication method is provided. The method includes: receiving, by the terminal device, a TPMI and a TRI transmitted by a network device; determining, by the terminal device based on the TPMI, a precoding matrix from a codebook corresponding to the TRI, wherein each codeword of the codebook includes 3 rows; performing, by the terminal device, a precoding process of data with the precoding matrix; and, transmitting, by the terminal device, data that has been precoded.

According to a second aspect of the present disclosure, a terminal device is provided. The terminal device includes a processor and a memory. The memory is configured to store a computer program. The processor is configured to call and run the computer program stored in this memory, and to perform the wireless communication method. The method includes: receiving a TPMI and a TRI transmitted by a network device; determining, based on the TPMI, a precoding matrix from a codebook corresponding to the TRI, wherein each codeword of the codebook includes 3 rows; performing a precoding process of data with the precoding matrix; and, transmitting data that has been precoded.

According to a third aspect of the present disclosure, a network device is provided. The network device includes a processor and a memory. The memory is configured to store a computer program. The processor is configured to call and run the computer program stored in this memory, and to perform a wireless communication method. The method includes: determining a precoding matrix from a codebook corresponding to a transmitted rank indicator TRI, wherein, each codeword in the codebook comprises 3 rows; transmitting the TRI and a transmit precoding matrix indicator (TPMI) corresponding to the precoding matrix to a terminal device. The TPMI is configured to be used by the terminal device to determine the precoding matrix from the codebook corresponding to the TRI.

### BRIEF DESCRIPTION OF THE DRAWINGS

FIG. 1 is a schematic diagram of a communication system architecture applied in an embodiment of the present disclosure.

FIG. 2 is a schematic diagram of a codebook-based PUSCH transmission according to an embodiment of the present disclosure.

FIG. 3 is a schematic flowchart of a wireless communication method according to an embodiment of the present disclosure.

FIG. 4 is a schematic flowchart of another wireless communication method according to an embodiment of the present disclosure.

FIG. 5 is a schematic block diagram of a terminal device according to an embodiment of the present disclosure.

FIG. 6 is a schematic block diagram of a network device according to an embodiment of the present disclosure.

FIG. 7 is a schematic block diagram of a communication device according to an embodiment of the present disclosure.

FIG. 8 is a schematic block diagram of an apparatus according to an embodiment of the present disclosure.

FIG. 9 is a schematic block diagram of a communication system according to an embodiment of the present disclosure.

### DETAILED DESCRIPTION

Technical solutions in embodiments of the present disclosure will be described in conjunction with accompanying drawings of the embodiments of the present disclosure. Obviously, the described embodiments are only a part of the embodiments but not all of them. All other embodiments obtained by a person of ordinary skills in the art based on embodiments of the present disclosure without creative efforts should all be within the protection scope of the present disclosure.

The technical solutions of the embodiments of the present disclosure may be applied to various communication systems, for example . a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), an internet of things (IoT), a wireless fidelity (Wi-Fi), a 5th-generation communication (5G) system or other communication systems, etc.

Generally speaking, a traditional communication system supports a limited number of connections and is easy to implement. However, with the development of the communication technology, the mobile communication system will not only support traditional communication, but would also support, for example, a device to device (D2D) communication, a machine to machine (M2M) communication, a machine type communication (MTC), a vehicle to vehicle (V2V) communication, or a vehicle to everything (V2X) communication, etc. The embodiment of the present disclosure may also be applied to these communication systems.

In some embodiments, the communication system of the present disclosure may be applied to a carrier aggregation (CA) scenario, a dual connectivity (DC) scenario, or a standalone (SA) network-deployment scenario.

In some embodiments, the communication system of the present disclosure may be applied to the unlicensed spectrum. The unlicensed spectrum may also be considered as shared spectrum. Alternatively, the communication system of the present disclosure may further be applied to the licensed spectrum. The licensed spectrum may also be considered as unshared spectrum.

Various embodiments would be described in the present disclosure in conjunction with the network device and the terminal device. The terminal device may also be referred to as a user equipment (UE), an access terminal, a user unit, a user station, a mobile site, a mobile station, a remote station, a remote terminal, a mobile device, a user terminal, a terminal, a wireless communication device, a user agent, or a user apparatus etc.

The terminal device may be a station (ST) of the WLAN. The terminal device may be a cellular telephone, a cordless telephone, a session initiation protocol (SIP) telephone, a wireless local loop (WLL) station, a personal digital assistant (PDA), a handheld device with the wireless communication function, a computing device or other processing device connected to a wireless modem, an in-vehicle device, a wearable device, a terminal device of a next-generation communication system (for example, the NR network), or a terminal device in a future-evolved public land mobile network (PLMN) etc.

In some embodiments of the present disclosure, the terminal device may be deployed on land, including indoor or outdoor, handheld, wearable or vehicle-mounted ones. The terminal device may also be deployed on water (such as in ships, etc.). The terminal device may also be deployed in the air (such as in an aircraft, a balloon, and in a satellite, etc.).

In the embodiments of the present disclosure, the terminal device be a mobile phone, a Pad, a computer with a wireless transceiver function, a virtual reality (VR) terminal device, an augmented reality (AR) terminal device, a wireless terminal for industrial control, a wireless terminal for self-driving, a wireless terminal device for remote medical, a wireless terminal device for smart grid, a wireless terminal device for transportation safety, a wireless terminal device for smart city or a wireless terminal device for smart home, an in-vehicle communication device, a wireless communication chip/an application specific integrated circuit (ASIC)/a system on chip (SoC) etc.

As an example, but not a limitation, in some embodiments of the present disclosure, the terminal device may further be a wearable device. The wearable device may also be referred to as a wearable smart device, which is a general term for devices which are wearable and developed from intelligent design of daily wearable articles through wearable techniques, such as glasses, gloves, watches, clothing, shoes etc. A wearable device is a portable device that is worn directly on the body or integrated into a user's clothing or accessories. The wearable device is more than a hardware device, but may also realize powerful functions through software support, data interaction, and cloud interaction. A broadly-defined wearable smart device includes: a full-featured, large-sized device that does not rely on a smartphone to achieve full or partial functionality, e.g., a smartwatch or smart glasses, etc.; as well as, a device that only focuses on a certain type of application functionality and must be used in conjunction with other devices such as a smartphone, e.g., various types of smart bracelets and smart jewelry that monitor physical characteristics.

In some embodiments of the present disclosure, the network device may be a device configured to communicate with a mobile device. The network device may be an access point (AP) in WLAN, a base transceiver station (BTS) in GSM or CDMA, or a NodeB (NB) in WCDMA, or an evolutional Node B (eNB or eNodeB) in the LTE, or a relay station or an access point, or an in-vehicle device, a wearable device and a network device or a station (gNB) in the NR network or a network device in the future-evolved PLMN network, or the network device in the NTN network.

As an example, but not a limitation, in some embodiments of the present disclosure, the network device may have a mobile feature. For example, the network device may be a mobile device. In some embodiments, the network device may be a satellite, a balloon station. For example, the satellite may be a low earth orbit (LEO) satellite, a medium earth orbit (MEO) satellite, a geostationary earth orbit (GEO) satellite, a high elliptical orbit (HEO) satellite etc. In some embodiments, the network device may also be a base station located on the land or in/on the water.

In some embodiments of the present disclosure, the network device may provide services for a cell, and the terminal device communicates with the network device through transmission resources (for example, frequency domain resources, or spectrum resources) used by the cell. The cell may be a cell corresponding to a network device (such as a base station). The cell may belong to a macro base station or a base station corresponding to a small cell. The small cell here may include: a metro cell, a Micro cell, a Pico cell, a Femto cell etc. These small cells have the characteristics of small coverage and low transmit power, and are suitable for providing high-rate data transmission service.

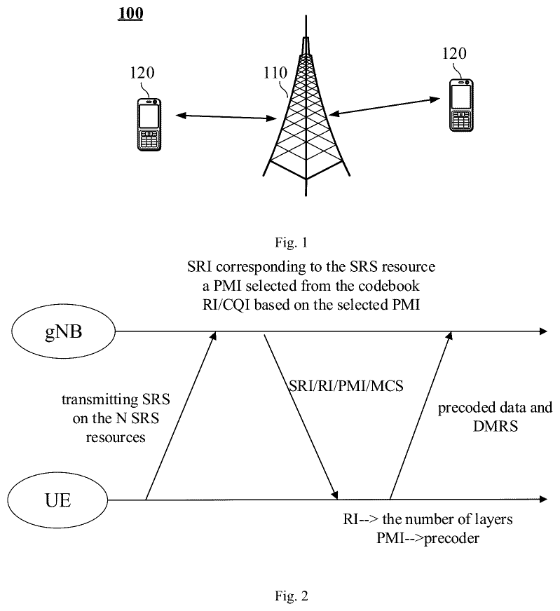

An exemplary communication system 100 applied in embodiments of the present disclosure is illustrated in FIG. 1. The communication system 100 may include a network device 110. The network device 110 may be a device communicating with the terminal device 120. The terminal device 120 may also be referred to as a communication terminal or a terminal. The network device 110 may provide communication coverage for a specific geographic area, and may communicate with terminal devices located in the coverage area.

FIG. 1 illustrates one network device and two terminal devices as an example In some embodiments, the communication system 100 may include a plurality of network devices. Other numbers of terminal devices may be included within the coverage area of each network device. Embodiments of the present disclosure do not impose any limitation on this.

In some embodiments, the communication system 100 may also include other network entities such as a network controller, a mobility management entity etc. Embodiments of the present disclosure do not impose any limitation on this.

It should be appreciated that, in some embodiments of the present disclosure, a device in the network/system with communication function may be referred to as the communication device. Taking the communication system 100 as illustrated in FIG. 1 as an example, the communication device may include a network device 110 and a terminal device 120 including the communication functions. The network device 110 and the terminal device 120 may be specific devices as described above and would not be repeated herein. The communication device may further include other devices in the communication system 100, such as a network controller, and other network entities such as a mobility management entity etc. Embodiments of the present disclosure do not impose any limitation on this.

It should be understood that, the terms “system” and “network” are often used interchangeably herein. The term “and/or” herein is merely an associating relationship for describing the associated objects, and indicates that there could be three relationships between the associated objects. For example, A and/or B may represent three situations: only A exists, A and B exist simultaneously, and only B exists. In the present disclosure, the character “/” generally indicates an “or” relationship between the associated objects before and after the character “/”.

The terminology used in the Detailed Description of the present disclosure is merely used for the purpose of explaining specific embodiments of the present disclosure and is not intended to limit the present disclosure. The terms “first”, “second”, “third” and “fourth” and the like in the specification, claim set and the figures in the present disclosure are used for distinguishing between different objects, and are not used for describing a particular sequential order. In addition, the terms ‘include’, ‘comprise’ and any variations thereof are intended to cover non-exclusive inclusion.

It should also be appreciated that, the expression “indication” referred to in embodiments of the present disclosure may be a direct indication, an indirect indication, or an indication of an associated relationship. For example, A indicating B may mean that, A directly indicates B, e.g., B may be obtained through A; it may mean that A indirectly indicates B, e.g., A indicates C, and B may be obtained through C; and it may mean that there is an associated relationship between A and B.

The “correspondence” mentioned in the embodiments of the present disclosure may indicate a direct or indirect correspondence between the two, or an association relationship between the two, or a relationship of indicating and being indicated, configuring, and being configured and the like.

The expression “predefined” or “preconfigured” referred to in the embodiments of the present disclosure may be realized by pre-storing corresponding codes, forms, or other means that may be used to indicate relevant information in advance in a device (e.g., including a terminal device and a network device). The specific implementation of which is not limited in embodiments of the present disclosure. For example, the expression “predefined” may mean defined in a protocol.

In embodiments of the present disclosure, it should also be appreciated that, the term “protocol” may refer to a standard protocol in the communication field, and may include, for example, an LTE protocol, an NR protocol, and related protocols to be applied in future communication systems, on which no limitation is imposed by the present disclosure.

To facilitate understanding of the technical scheme of the embodiments of the present disclosure, the technical schemes of the present disclosure are detailed below through concrete embodiments. The following relevant technologies may be arbitrarily combined with the technical schemes of the embodiments of the present disclosure as optional schemes, and they all belong to the protection scope of the embodiments of the present disclosure. Embodiments of the present disclosure include at least some of the following contents.

To facilitate a better understanding of the embodiments of the present disclosure, the uplink codebook transmission related in the present disclosure is discussed.

When the terminal device transmits the uplink data (e.g., the physical uplink shared channel (PUSCH)), the uplink data needs to be subjected to a pre-coding processing to obtain an uplink pre-coding gain. The pre-coding processing is generally divided into two parts: an analog domain processing and a digital domain processing. During the analog domain processing, for the transmitted analog signal, a radio frequency signal is generally mapped to a physical antenna by means of a beam-forming approach. During the digital domain processing, the digital signal is generally processed in the baseband, a precoding matrix is used to pre-code the digital signal and map the data from a transport layer to a radio frequency port. Due to limited number of RF channels of the terminal, two processing approaches are generally adopted at the same time, i.e., the digital signal is precoded, and then the analog signal is formed with a beam or beam-formed. The PUSCH transmissions are classified into codebook-based transmissions and non-codebook-based transmissions according to the precoding approach.

In the uplink codebook-based precoding approach, the network side may configure, for the terminal, a pool of sounding reference signal (SRS) resources dedicated to codebook transmission. The terminal may transmit SRSs on a plurality of SRS resources in the pool, and the SRSs on each SRS resource may adopt different beams. The network side selects the best SRS resource for obtaining the uplink channel state information (CSI) therefrom. At the same time, the resource index is indicated to the terminal via the SRS resource indicator (SRI), so that the terminal is enabled to use a beam corresponding to the SRS resource for analog beam forming of the data. At the same time, the network side may indicate the rank indication (RI) and the TPMI through the downlink control information (DCI). The terminal may determine, according to the RI and the TPMI, the uplink precoding matrix corresponding to the TPMI from the codebook.

As illustrated in FIG. 2, the codebook-based PUSCH transmission may include the following operations: the UE transmits the SRS on N SRS resources; the gNB determines the SRI corresponding to an SRS resource and selects a precoding matrix indicator (PMI) from the codebook, and determines the RI or channel quantity indicator (CQI) based on the selected PMI; the gNB transmits the SRI/RI/PMI/modulation and coding scheme (MCS) to the UE; the UE determines the number of layers based on the RI, and determines the precoder based on PMI; and the UE transmits precoded data and a demodulation reference signal (DMRS) to the gNB.

To facilitate a better understanding of the embodiments of the present disclosure, an uplink codebook related in the present disclosure is discussed.

The uplink supports a 2-port PUSCH transmission and a 4-port PUSCH transmission. The codebook used in a case of 2 antenna ports and 1 transport layer is illustrated in Table 1. The codebook used in a case of 2 antenna ports and 1 transport layer (corresponding to discrete Fourier transform-spread-orthogonal frequency division multiplexing (DFT-S-OFDM)) is illustrated in Table 2. The codebook used in a case of 4 antenna ports and 1 transport layer (corresponding to cyclic prefix-orthogonal frequency division multiplexing (CP-OFDM)) is illustrated in Table 3. The codebook used in a case of 2 antenna ports and 2 transport layers (corresponding to the DFT-S-OFDM) is illustrated in Table 4. The codebook used in a case of 4 antenna ports and 2 transport layers (corresponding to CP-OFDM) is illustrated in Table 5. The codebook used in a case of 4 antenna ports and 3 transport layers (corresponding to CP-OFDM) is illustrated in Table 6. The codebook used in a case of 4 antenna ports and 4 transport layers (corresponding to CP-OFDM) is illustrated in Table 7.

TABLE 1

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 2

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}1 \\ 0 \\ 1 \\ 0\end{matrix} ]$ | $\frac{1}{2} [ \begin{matrix}1 \\ 0 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 3

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 4

| | W | | |
|---|---|---|---|
| TPMI index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 5

| | W | | | |
|---|---|---|---|---|
| TPMI index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | [symbol] | [symbol] |

TABLE 6

| | W | | | |
|---|---|---|---|---|
| TPMI index | (ordered from left to right in increasing order of TPMI index) | | | |
| 0-2 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 7

| | W | | | |
|---|---|---|---|---|
| TPMI index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

At this stage, the codebooks for 2 antenna ports and 4 antenna ports are supported. However, some terminals may include 3 transmitting antennas. Due to lack of codebooks for 3 antenna ports, these terminals may have to degrade to 2-antenna-port transmissions, i.e., perform the uplink transmission using codebooks for 2 ports. Since the gain of the 3 transmitting antennas cannot be fully utilized, the spectral efficiency is affected. In addition, since the 2-port transmission could only support a maximum of two-stream transmissions, the peak rate may also be affected.

Based on the above-mentioned issues, the present disclosure proposes an uplink codebook design scheme, in which a codebook supporting the uplink transmission based on 3 antenna ports is designed. In this way, the antenna gains of the 3-antenna-port transmission may be fully utilized. The spectral efficiency and the peak rate may be improved as compared to degrading the 3-antenna terminals into 2-port transmission.

The technical solutions of the present disclosure are described in detail below by means of specific embodiments.

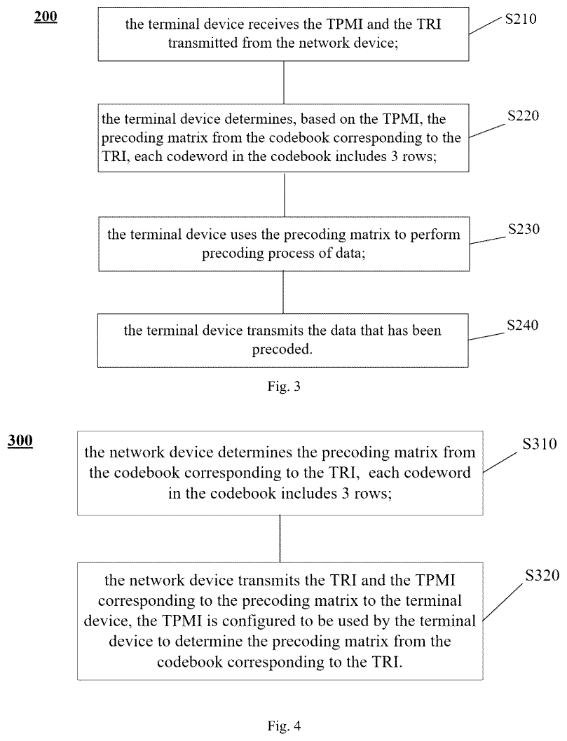

FIG. 3 is a schematic flowchart of a wireless communication method 200 according to embodiments of the present disclosure. As illustrated in FIG. 3, the wireless communication method 200 may include at least a part of operations at blocks of FIG. 3 illustrated below.

At block S210, the terminal device may receive the TPMI and the TRI transmitted from the network device.

At block S220, the terminal device may determine, based on the TPMI, the precoding matrix from the codebook corresponding to the TRI. Each codeword in the codebook includes 3 rows.

At block S230, the terminal device uses the precoding matrix to perform precoding process of data.

At block S240, the terminal device transmits the data that has been precoded.

In some embodiments of the present disclosure, each codeword of the codebook includes 3 rows. In other words, the codebook supports the uplink transmissions based on the 3 antenna ports. In this way, the antenna gains of the 3-antenna-port transmission may be fully utilized. The spectral efficiency may be improved as compared to degrading the 3-antenna terminals into 2-port transmission. The uplink transmission of 3 layers is also supported, thereby increasing the peak rate.

It should be noted that, each row of each codeword in this codebook corresponds to an antenna port, thus the 3 rows correspond to 3 antenna ports.

In some embodiments, the network device may indicate the TPMI through the downlink control information (DCI). Of course, the network device may also indicate the TPMI by other signaling indication, which is not limited in the present disclosure.

In some embodiments, the terminal device may obtain the transmitted rank indicator (TRI) from the DCI indicating the TPMI. The TRI is configured to indicate the number of transport layers. The TRI and the TPMI may be coded jointly.

In some embodiments, the number of transport layers may be 1, 2 or 3.

In some embodiments, when determining the vectors/matrices included in the codebook, the minimum chord distance or the average chord distance between the codewords may be maximized to select the codewords. That is, when the codebooks have a particular size, a candidate codebook with the greatest minimum chord distance or the greatest average chord distance between the codewords is selected, from a plurality of candidate codebooks consisting of particular vectors, as the codebook.

In some embodiments, in a case where the number of the transport layers indicated by the TRI is 1, the codebook includes at least one of the following vectors: a first vector, a second vector, a third vector, and a fourth vector. In some embodiments, the first vector is a constant-modulus 3-discrete Fourier transform (DFT) vector. Three elements or entries of the second vector are all constant-modulus quadrature phase shift keying (QPSK) elements. In the third vector, one element is 1, one element is a QPSK element and one element is 0. In the fourth vector, one element is 1, the other two elements are 0.

In other words, in some embodiments of the present disclosure, a single layer of codeword may be generated based on the constant-modulus 3-DFT vectors. Alternatively, a single layer of codeword may be generated based on the constant-modulus QPSK elements. The length of each of 3-DFT vectors may be 3.

It should be noted that, the set of the QPSK elements is {1, −1, j, −j}. In other words, the QPSK element is an element in the set of the QPSK elements.

In some embodiments, the first vector is a constant-modulus 3-DFT vector. In other words, the first vector is a constant-modulus DFT vector with a length of 3. Constant modulus means that, the modulus of each element of the first vector is identical.

In some embodiments, the first vector is at least one of the 3O vectors. The 3O vectors are obtained by performing O times of oversampling on the DFT vector with a length of 3. O is a positive integer.

In some embodiments, the first vector is at least one vector of the following vector set:

$${W}_{m}^{( 1 )} = {\frac{1}{\sqrt{3}} [ \begin{matrix}1 & {e}^{j \frac{2 π m}{3 O}} & {e}^{j \frac{4 π m}{3 O}}\end{matrix} ]}^{T}$$

$$m = 0 , 1 , … 3 O - 1 ;$$

wherein, O is a positive integer.

In some embodiments, O=1, or O=3, or O=5. For example, when O=1, the first vector includes all 3 vectors of the above-mentioned vector set. For another example, when O=3, the first vector includes 4 vectors of the above-mentioned vector set, the first vector includes 8 vectors of the above-mentioned vector set. For yet another example, O=5, the first vector includes all 15 vectors of the above-mentioned vector set.

It should be noted that, in the first vector, 1/\sqrt{3} is the power normalization factor, which in practical application may be replaced with other values such as 1, or 1/√(6), or 1/\sqrt{5}, or 1/\sqrt{2}, if the power normalization operation is not performed during the precoding process.

In some embodiments, all three elements of the second vector are constant-modulus (i.e., each element of the second vector has the same modulus) QPSK elements. In other words, each element is from the QPSK element set {1, −1, j, −j}.

Specifically, for example, the first element of the second vector is 1. The second element and the third element of the second vector are both QPSK elements. i.e., the second vector is [1; x; y]^{T}, where x and y are from the set {1, −1, j, −j}. For data that undergoes a DFT transformation and data that does not undergo a DFT transformation, different vectors may be used.

In some embodiments, the second vector is at least one vector of the following vector set:

$$\frac{1}{\sqrt{3}} [ \begin{matrix}1 \\ 1 \\ j\end{matrix} ] ,$$

$$\frac{1}{\sqrt{3}} [ \begin{matrix}1 \\ 1 \\ - j\end{matrix} ] ,$$

$$\frac{1}{\sqrt{3}} [ \begin{matrix}1 \\ - 1 \\ j\end{matrix} ] ,$$

$$\frac{1}{\sqrt{3}} [ \begin{matrix}1 \\ - 1 \\ - j\end{matrix} ] ,$$

$$\frac{1}{\sqrt{3}} [ \begin{matrix}1 \\ j \\ 1\end{matrix} ] ,$$

$$\frac{1}{\sqrt{3}} [ \begin{matrix}1 \\ j \\ - 1\end{matrix} ] ,$$

$$\frac{1}{\sqrt{3}} [ \begin{matrix}1 \\ - j \\ 1\end{matrix} ] ,$$

$$\frac{1}{\sqrt{3}} [ \begin{matrix}1 \\ - j \\ - 1\end{matrix} ] .$$

It should be noted that, in the second vector, 1/\sqrt{3} is the power normalization factor, which in practical application may be replaced with other values such as 1, or 1/\sqrt{6}, or 1/\sqrt{5}, or 1/\sqrt{2} if the power normalization operation is not performed during the precoding process.

Specifically, for example, the second vector may include all the following 8 vectors:

$$\frac{1}{\sqrt{3}} [ \begin{matrix}1 \\ 1 \\ j\end{matrix} ] ,$$

$$\frac{1}{\sqrt{3}} [ \begin{matrix}1 \\ 1 \\ - j\end{matrix} ] ,$$

$$\frac{1}{\sqrt{3}} [ \begin{matrix}1 \\ - 1 \\ j\end{matrix} ] ,$$

$$\frac{1}{\sqrt{3}} [ \begin{matrix}1 \\ - 1 \\ - j\end{matrix} ] ,$$

$$\frac{1}{\sqrt{3}} [ \begin{matrix}1 \\ j \\ 1\end{matrix} ] ,$$

$$\frac{1}{\sqrt{3}} [ \begin{matrix}1 \\ j \\ - 1\end{matrix} ] ,$$

$$\frac{1}{\sqrt{3}} [ \begin{matrix}1 \\ - j \\ 1\end{matrix} ] ,$$

$$\frac{1}{\sqrt{3}} [ \begin{matrix}1 \\ - j \\ - 1\end{matrix} ] .$$

In some embodiments, in the third vector, one element is 1, one element is a QPSK element and one element is 0. Specifically, the third vector is [1; 0; x]^{T} or [1; x; 0]^{T} or [0; 1; x]^{T}, wherein, x is from the set {1, −1, j, −j}.

In some embodiments, the third vector is at least one vector of the following vector set:

$$\frac{1}{\sqrt{3}} [ \begin{matrix}1 \\ 1 \\ 0\end{matrix} ] ,$$

$$\frac{1}{\sqrt{3}} [ \begin{matrix}1 \\ - 1 \\ 0\end{matrix} ] ,$$

$$\frac{1}{\sqrt{3}} [ \begin{matrix}1 \\ j \\ 0\end{matrix} ] ,$$

$$\frac{1}{\sqrt{3}} [ \begin{matrix}1 \\ - j \\ 0\end{matrix} ] ,$$

$$\frac{1}{\sqrt{3}} [ \begin{matrix}1 \\ 0 \\ 1\end{matrix} ] ,$$

$$\frac{1}{\sqrt{3}} [ \begin{matrix}1 \\ 0 \\ - 1\end{matrix} ] ,$$

$$\frac{1}{\sqrt{3}} [ \begin{matrix}1 \\ 0 \\ j\end{matrix} ] ,$$

$$\frac{1}{\sqrt{3}} [ \begin{matrix}1 \\ 0 \\ - j\end{matrix} ] .$$

It should be noted that, in the third vector, 1/\sqrt{3} is the power normalization factor, which in practical application may be replaced with other values such as 1, or 1/\sqrt{6}, or 1/\sqrt{5}, or 1/\sqrt{2} if the power normalization operation is not performed during the precoding process.

Specifically, for example, the third vector may include all the following 4 vectors:

$$\frac{1}{\sqrt{3}} [ \begin{matrix}1 \\ 1 \\ 0\end{matrix} ] ,$$

$$\frac{1}{\sqrt{3}} [ \begin{matrix}1 \\ - 1 \\ 0\end{matrix} ] ,$$

$$\frac{1}{\sqrt{3}} [ \begin{matrix}1 \\ j \\ 0\end{matrix} ] ,$$

$$\frac{1}{\sqrt{3}} [ \begin{matrix}1 \\ - j \\ 0\end{matrix} ] .$$

In some embodiments, the fourth vector is at least one vector of the following vector set:

$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ] .$$

It should be noted that, in the fourth vector, 1/\sqrt{3} is the power normalization factor, which in practical application may be replaced with other values such as 1, or 1/\sqrt{6}, or 1/\sqrt{5}, or 1/\sqrt{2} if the power normalization operation is not performed during the precoding process.

Specifically, for example, the fourth vector may include all the following 3 vectors:

$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ] .$$

In some embodiments, the vectors included in the codebook are determined by a type of the codebook configured by the network device.

Specifically, for example, in a case where the type of the codebook is a coherent codebook, the codebook includes the first vector, the third vector, and the fourth vector, or, the codebook includes the second vector, the third vector, and the fourth vector.

Specifically, for another example, in a case where the type of the codebook is a partial coherent codebook, the codebook includes the third vector and the fourth vector.

Specifically, for yet another example, in a case where the type of the codebook is a non-coherent codebook, the codebook includes the fourth vector.

In some embodiments, in a case where the number of the transport layer indicated by the TRI is 2, the codebook includes at least one of the following precoding matrices: a first precoding matrix, a second precoding matrix, a third precoding matrix, a fourth precoding matrix, and a fifth precoding matrix.

In some embodiments, each column of the first precoding matrix is a constant-modulus DFT vector. Each non-zero element of the second precoding matrix is a constant-modulus QPSK element. The first column of the third precoding matrix consists of constant-modulus QPSK elements, the second column of the third precoding matrix consists of constant-modulus non-QPSK elements, and the second column vector of the third precoding matrix is orthogonal to the first column vector of the third precoding matrix. A first column of the fourth precoding matrix includes two QPSK elements, a second column of the fourth precoding matrix includes one QPSK element, these three QPSK elements are in different rows, and the other elements are 0. Each of the two columns of the fifth precoding matrix includes one element whose value is 1, these two elements are in different rows, and the other elements of the fifth precoding matrix are all 0.

In some embodiments, each column of the first precoding matrix is a constant-modulus (i.e., the modulus of each element of that column is the same) 3-DFT vector. Specifically, the two column vectors of the first precoding matrix are two vectors of the 3O vectors. The 3O vectors are obtained by performing O times of oversampling on the DFT vector with a length of 3. O is a positive integer.

In some embodiments, the first precoding matrix is at least one of the following precoding matrices set:

$${W}_{m}^{( 2 )} = \frac{1}{\sqrt{6}} [ \begin{matrix}1 & 1 \\ {e}^{j \frac{2 π m}{3 O}} & {e}^{j ( \frac{2 π m}{3 O} + \frac{2 π}{3} )} \\ {e}^{j \frac{4 π m}{3 O}} & {e}^{j ( \frac{4 π m}{3 O} + \frac{4 π}{3} )}\end{matrix} ] ,$$

wherein, O is a positive integer.
m=0, 1, . . . 3O−1

It should be noted that, in the first precoding matrix, 1/\sqrt{6} is the power normalization factor, which in practical application may be replaced with other values such as 1, or 1/\sqrt{3}, or 1/\sqrt{5}, or 1/\sqrt{2}, if the power normalization operation is not performed during the precoding process.

In some embodiments, O=1, or O=3, or O=5.

For example, when O=1, the first precoding matrix includes all the 3 matrices of the above-mentioned precoding matrices set. For another example, when O=3, the first precoding matrix includes 4 or 8 matrices of the above-mentioned precoding matrices set.

In some embodiments, the elements of the first row of the second precoding matrix are all 1, other elements are QPSK elements, and the two column vectors are not identical and not orthogonal. In some embodiments of the present disclosure, the second precoding matrix includes a plurality of precoding matrices in which the elements of the first two rows are the same and the elements of the third row are different. The second precoding matrix is at least one of the following precoding matrices set:

$$\frac{1}{\sqrt{6}} [ \begin{matrix}1 & 1 \\ 1 & - 1 \\ 1 & j\end{matrix} ] , \frac{1}{\sqrt{6}} [ \begin{matrix}1 & 1 \\ 1 & - 1 \\ 1 & - j\end{matrix} ] , \frac{1}{\sqrt{6}} [ \begin{matrix}1 & 1 \\ 1 & - 1 \\ - 1 & j\end{matrix} ] , \frac{1}{\sqrt{6}} [ \begin{matrix}1 & 1 \\ 1 & - 1 \\ - 1 & - j\end{matrix} ] .$$

It should be noted that, in the second precoding matrix, 1/\sqrt{6} is the power normalization factor, which in practical application may be replaced with other values such as 1, or 1/\sqrt{3}, or 1/\sqrt{5}, or 1/\sqrt{2}, if the power normalization operation is not performed during the precoding process.

Specifically, for example, the second precoding matrix includes all 4 of the above-mentioned precoding matrices. The first two rows of the 4 precoding matrices are identical, but the third rows of the 4 precoding matrices are different from each other.

In some embodiments, the two column vectors of the second precoding matrix are orthogonal. One of the elements of the second column vector is 0 and all other elements are non-zero. For example, a form of the second precoding matrix may be

$$\frac{1}{\sqrt{5}} [ \begin{matrix}1 & 1 \\ x & 0 \\ y & z\end{matrix} ] or \frac{1}{\sqrt{5}} [ \begin{matrix}1 & 1 \\ x & z \\ y & 0\end{matrix} ] ,$$

where x, y and z are all from the set {1, −1, j, −j}. The second precoding matrix is at least one of the following precoding matrices set:

$$\frac{1}{\sqrt{5}} [ \begin{matrix}1 & 1 \\ 1 & 0 \\ 1 & - 1\end{matrix} ] , \frac{1}{\sqrt{5}} [ \begin{matrix}1 & 1 \\ 1 & 0 \\ - 1 & 1\end{matrix} ] , \frac{1}{\sqrt{5}} [ \begin{matrix}1 & 1 \\ 1 & 0 \\ j & - j\end{matrix} ] , \frac{1}{\sqrt{5}} [ \begin{matrix}1 & 1 \\ 1 & 0 \\ - j & j\end{matrix} ] , \frac{1}{\sqrt{5}} [ \begin{matrix}1 & 1 \\ - 1 & 0 \\ 1 & - 1\end{matrix} ] , \frac{1}{\sqrt{5}} [ \begin{matrix}1 & - 1 \\ 0 & - 1 \\ 1 & 1\end{matrix} ] , \frac{1}{\sqrt{5}} [ \begin{matrix}1 & 1 \\ - 1 & 0 \\ j & - j\end{matrix} ] , \frac{1}{\sqrt{5}} [ \begin{matrix}1 & 1 \\ - 1 & 0 \\ - j & j\end{matrix} ] , \frac{1}{\sqrt{5}} [ \begin{matrix}1 & 1 \\ j & 0 \\ 1 & - 1\end{matrix} ] , \frac{1}{\sqrt{5}} [ \begin{matrix}1 & 1 \\ j & 0 \\ - 1 & 1\end{matrix} ] , \frac{1}{\sqrt{5}} [ \begin{matrix}1 & 1 \\ j & 0 \\ j & - j\end{matrix} ] , \frac{1}{\sqrt{5}} [ \begin{matrix}1 & 1 \\ j & 0 \\ - j & j\end{matrix} ] , \frac{1}{\sqrt{5}} [ \begin{matrix}1 & 1 \\ - j & 0 \\ 1 & - 1\end{matrix} ] , \frac{1}{\sqrt{5}} [ \begin{matrix}1 & 1 \\ - j & 0 \\ - 1 & 1\end{matrix} ] , \frac{1}{\sqrt{5}} [ \begin{matrix}1 & 1 \\ - j & 0 \\ j & - j\end{matrix} ] , \frac{1}{\sqrt{5}} [ \begin{matrix}1 & 1 \\ - j & 0 \\ - j & j\end{matrix} ] .$$

Specifically, for example, the second precoding matrix may include 4 or 8 precoding matrices of the above-mentioned matrices.

It should be noted that, in the second precoding matrix, 1/\sqrt{5} is a power normalization factor, and the power normalization factor may also be replaced with 1/\sqrt{6}, or 1/\sqrt{3}, or 1/\sqrt{2}. In practical application, if the power normalization operation is not performed during the precoding process, the power normalization factor may also be replaced with other values, such as 1.

In some embodiments, the third precoding matrix is at least one of the following precoding matrices set:

$$\frac{1}{\sqrt{6}} [ \begin{matrix}1 & 1 \\ 1 & - \frac{1}{2} + \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ 1 & \frac{1}{2} + \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ 1 & - \frac{1}{2} + \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ - 1 & \frac{1}{2} + \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ j & - \frac{\sqrt{3}}{2} - \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ j & \frac{\sqrt{3}}{2} - \frac{1}{2} j \\ j & \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ - j & - \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ - j & \frac{\sqrt{3}}{2} + \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ - j & - \frac{\sqrt{3}}{2} + \frac{1}{2} j \\ j & \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ - j & - \frac{\sqrt{3}}{2} + \frac{1}{2} j\end{matrix} ] ..$$

It should be noted that, in the third precoding matrix, 1/\sqrt{6} is the power normalization factor, which in practical application may be replaced with other values such as 1, or 1/\sqrt{3}, or 1/\sqrt{5}, or 1/\sqrt{2}, if the power normalization operation is not performed during the precoding process.

In some embodiments, one element in each of the first column and the second column of the fourth precoding matrix is 1.

In some embodiments, the fourth precoding matrix is at least one of the following precoding matrices set:

$$\frac{1}{\sqrt{3}} [ \begin{matrix}1 & 0 \\ 1 & 0 \\ 0 & 1\end{matrix} ] , \frac{1}{\sqrt{3}} [ \begin{matrix}1 & 0 \\ - 1 & 0 \\ 0 & 1\end{matrix} ] , \frac{1}{\sqrt{3}} [ \begin{matrix}1 & 0 \\ j & 0 \\ 0 & 1\end{matrix} ] , \frac{1}{\sqrt{3}} [ \begin{matrix}1 & 0 \\ - j & 0 \\ 0 & 1\end{matrix} ] , \frac{1}{\sqrt{3}} [ \begin{matrix}1 & 0 \\ 0 & 1 \\ 1 & 0\end{matrix} ] , \frac{1}{\sqrt{3}} [ \begin{matrix}1 & 0 \\ 0 & 1 \\ - 1 & 0\end{matrix} ] , \frac{1}{\sqrt{3}} [ \begin{matrix}1 & 0 \\ 0 & 1 \\ j & 0\end{matrix} ] , \frac{1}{\sqrt{3}} [ \begin{matrix}1 & 0 \\ 0 & 1 \\ - j & 0\end{matrix} ] , \frac{1}{\sqrt{3}} [ \begin{matrix}0 & 1 \\ 1 & 0 \\ 1 & 0\end{matrix} ] , \frac{1}{\sqrt{3}} [ \begin{matrix}0 & 1 \\ 1 & 0 \\ - 1 & 0\end{matrix} ] , \frac{1}{\sqrt{3}} [ \begin{matrix}0 & 1 \\ 1 & 0 \\ j & 0\end{matrix} ] , \frac{1}{\sqrt{3}} [ \begin{matrix}0 & 1 \\ 1 & 0 \\ - j & 0\end{matrix} ] .$$

It should be noted that, in the fourth precoding matrix, 1/\sqrt{3} is a power normalization factor, and the power normalization factor may also be replaced with 1/√6, or 1/√5, or 1/√2. In practical application, if the power normalization operation is not performed during the precoding process, the power normalization factor may also be replaced with other values, such as 1.

Specifically, for example, the fourth precoding matrix includes the 1^{st} to the 4^{th} matrices, or the 5^{th} to the 8^{th} matrices, or the 9^{th} to the 12^{th} matrices of the above-mentioned precoding matrices.

In some embodiments, the fifth precoding matrix is at least one of the following precoding matrices set:

$$\frac{1}{\sqrt{3}} [ \begin{matrix}1 & 0 \\ 0 & 1 \\ 0 & 0\end{matrix} ] , \frac{1}{\sqrt{3}} [ \begin{matrix}1 & 0 \\ 0 & 0 \\ 0 & 1\end{matrix} ] , \frac{1}{\sqrt{3}} [ \begin{matrix}0 & 0 \\ 1 & 0 \\ 0 & 1\end{matrix} ] .$$

It should be noted that, in the fifth precoding matrix, 1/\sqrt{3} is a power normalization factor, and the power normalization factor may also be replaced with 1/\sqrt{2}, or 1/\sqrt{6}, or 1/\sqrt{5}. In practical application, if the power normalization operation is not performed during the precoding process, the power normalization factor may also be replaced with other values, such as 1.

Specifically, for example, the fifth precoding matrix may include all three of the above-mentioned precoding matrices.

In some embodiments, the precoding matrices included in the codebook are determined by the type of the codebook configured by the network device.

Specifically, for example, in a case where the type of the codebook is the coherent codebook, the codebook includes the first precoding matrix, the fourth precoding matrix and the fifth precoding matrix. Alternatively, the codebook includes the second precoding matrix, the fourth precoding matrix and the fifth precoding matrix. Alternatively, the codebook includes the third precoding matrix, the fourth precoding matrix and the fifth precoding matrix.

Specifically, for yet another example, in a case where the type of the codebook is the partial coherent codebook, the codebook includes the fourth precoding matrix and the fifth precoding matrix.

Specifically, for yet another example, in a case where the type of the codebook is the non-coherent codebook, the codebook includes the fifth precoding matrix.

In some embodiments, two layers of codewords may be generated based on the constant-modulus 3-DFT vectors. Alternatively, a two-layer codeword may be generated based on the constant-modulus QPSK elements. For example, the vectors of the two layers are not orthogonal.

In some embodiments, the first layer vector of the single layer or the double layers is generated by using constant-modulus QPSK elements. The second layer vector is generated by using non-QPSK elements and is orthogonal to the first layer vector.

In some embodiments, the codeword is generated based on constant-modulus QPSK elements. The two layer vectors are orthogonal to each other, and the second layer vector is transmitted only by using 2 ports.

In some embodiments, in a case where the layer number of the transport layers indicated by the TRI is 3, an identity matrix of size 3 is included in the codebook. The identity matrix of size 3 is a 3×3 identity matrix.

For example, when the rank indicated by the TRI is 3, the codebook is:

$$\frac{1}{\sqrt{3}} [ \begin{matrix}1 & 0 & 0 \\ 0 & 1 & 0 \\ 0 & 0 & 1\end{matrix} ] .$$

It should be noted that, in the identity matrix, 1/\sqrt{3} is a power normalization factor, and the power normalization factor may also be replaced with 1/\sqrt{6}. In practical application, if the power normalization operation is not performed during the precoding process, the power normalization factor may also be replaced with other values, such as 1, or 1/\sqrt{2}, or 1/\sqrt{5}.

In some embodiments, the terminal device transmits an SRS configured for the uplink codebook transmission. The SRS may be used by the network device to determine the TPMI. Specifically, for example, before the operation at block S210, the terminal device transmits the SRS configured for the uplink codebook transmission. In other words, the network device may determine the TPMI based on the SRS configured for the uplink codebook transmission.

In some embodiments, the SRS is an SRS for 3 antenna ports. In other words, the SRS resource of the SRS is configured with 3 antenna ports. The usage of the SRS resource is configured as a codebook.

Therefore, the codebook designed in embodiments of the present disclosure may support the uplink transmissions based on 3 antenna ports. As compared to the way of degrading the 3 antenna terminals into 2-port transmission, the antenna gains of the 3-antenna transmission may be fully utilized, and the spectral efficiency may be effectively increased. At the same time, as compared to the approach that may only support up to two layers for transmission, the codebook designed in embodiments of the present disclosure may support 3 layers for uplink transmission, thereby increasing the peak rate.

Terminal-side embodiments of the present disclosure are described in detail above in conjunction with FIG. 3. Network-side embodiments of the present disclosure are described in detail below in conjunction with FIG. 4. It should be appreciated that, the network-side embodiments and the terminal-side embodiments may be correspondent to each other, and similar descriptions may refer to the terminal-side embodiments.

FIG. 4 is a schematic flowchart of a wireless communication method 300 according to embodiments of the present disclosure. As illustrated in FIG. 4, the wireless communication method 300 may include at least a part of the operations at blocks illustrated below in FIG. 4.

At block S310, the network device determines the precoding matrix from the codebook corresponding to the TRI. Each codeword in the codebook includes 3 rows.

At block S320, the network device transmits the TRI and the TPMI corresponding to the precoding matrix to the terminal device. The TPMI is used by the terminal device to determine the precoding matrix from the codebook corresponding to the TRI.

In some embodiments of the present disclosure, each codeword in the codebook includes 3 rows. In other words, the codebook supports the uplink transmissions based on the 3 antenna ports. In this way, the antenna gains of the 3-antenna-port transmission may be fully utilized. The spectral efficiency may be improved as compared to degrading the 3 antenna terminals into the 2-port transmission. The uplink transmission of 3 layers is also supported, thereby increasing the peak rate.

It should be noted that, each row of each codeword in the codebook corresponds to an antenna port, thus the 3 rows correspond to 3 antenna ports.

In some embodiments, the network device may indicate the TPMI through the downlink control information (DCI). Of course, the network device may also indicate the TPMI by other signaling indication, which is not limited in the present disclosure.

In some embodiments, the network device may carry the TRI in the DCI that is configured to indicate the TPMI. The TRI is configured to indicate the number of transport layers. The TRI and the TPMI may be coded jointly.

In some embodiments, the number of transport layers may be 1, 2 or 3.

In some embodiments, when determining the vectors/matrices t included in the codebook, the minimum chord distance or the average chord distance between the codewords may be maximized to select the codewords.

In some embodiments, in a case where the number of the transport layers indicated by the TRI is 1, the codebook includes at least one of the following vectors: a first vector, a second vector, a third vector, and a fourth vector. The first vector is a constant-modulus 3-DFT vector. Three elements of the second vector are all constant-modulus QPSK elements. In the third vector, one element is 1, one element is a QPSK element and one element is 0. In the fourth vector, one element is 1, the other two elements are 0.

In other words, in some embodiments of the present disclosure, a single layer of codeword may be generated based on the constant-modulus 3-DFT vectors. Alternatively, a single layer of codeword may be generated based on the constant-modulus QPSK elements.

It should be noted that, the set of the QPSK elements is {1, −1, j, −j}. In other words, the QPSK element is an element in the set of the QPSK elements.

In some embodiments, the first vector is a constant-modulus 3-DFT vector. In other words, the first vector is a constant-modulus DFT vector with a length of 3. Constant modulus means that, the modulus of each element of the first vector is the same.

In some embodiments, the first vector is at least one of the 3O vectors. The 3O vectors are obtained by performing O times of oversampling on the DFT vector with a length of 3. O is a positive integer.

In some embodiments, the first vector is at least one vector of the following vector set:

$${W}_{m}^{( 1 )} = \frac{1}{\sqrt{3}} [ \begin{matrix}1 & {e}^{j \frac{2 π m}{3 O}} & {e}^{j \frac{4 π m}{3 O}}\end{matrix} ] ,$$

wherein, O is a positive integer.
m=0, 1, . . . 3O−1

In some embodiments, O=1, or O=3, or O=5. For example, when O=1, the first vector includes all 3 vectors of the above-mentioned vector set. For another example, when O=3, the first vector includes all 4 vectors of the above-mentioned vector set, or, the first vector includes 8 vectors of the above-mentioned vector set. For yet another example, when O=5, the first vector includes all 15 vectors of the above-mentioned vector set.

It should be noted that, in the first vector, 1/\sqrt{3} is the power normalization factor, which in practical application may be replaced with other values such as 1, or 1/\sqrt{5}, or 1/\sqrt{2}, or 1/\sqrt{6}, if the power normalization operation is not performed during the precoding process.

In some embodiments, all three elements of the second vector are constant-modulus (i.e., each element of the second vector has the same modulus) QPSK elements. In other words, each element is from the QPSK element set {1, −1, j, −j}.

Specifically, for example, the first element of the second vector is 1. The second element and the third element of the second vector are both QPSK elements. i.e., the second vector is [1; x; y]^{T}, where x and y are from the set {1, −1, j, −j}. For data that undergoes the DFT transformation and data that does not undergo the DFT transformation, different vectors can be used.

In some embodiments, the second vector is at least one vector of the following vector set:

$$\frac{1}{\sqrt{3}} [ \begin{matrix}1 \\ 1 \\ j\end{matrix} ] , \frac{1}{\sqrt{3}} [ \begin{matrix}1 \\ 1 \\ - j\end{matrix} ] , \frac{1}{\sqrt{3}} [ \begin{matrix}1 \\ - 1 \\ j\end{matrix} ] , \frac{1}{\sqrt{3}} [ \begin{matrix}1 \\ - 1 \\ - j\end{matrix} ] , \frac{1}{\sqrt{3}} [ \begin{matrix}1 \\ j \\ 1\end{matrix} ] , \frac{1}{\sqrt{3}} [ \begin{matrix}1 \\ j \\ - 1\end{matrix} ] , \frac{1}{\sqrt{3}} [ \begin{matrix}1 \\ - j \\ 1\end{matrix} ] , \frac{1}{\sqrt{3}} [ \begin{matrix}1 \\ - j \\ - 1\end{matrix} ] .$$

It should be noted that, in the second vector, 1/\sqrt{3} is the power normalization factor, which in practical application may be replaced with other values such as 1, or 1/\sqrt{5}, or 1/\sqrt{2}, or 1/\sqrt{6}, if the power normalization operation is not performed during the precoding process.

Specifically, for example, the second vector may include all the following 8 vectors:

$$\frac{1}{\sqrt{3}} [ \begin{matrix}1 \\ 1 \\ j\end{matrix} ] , \frac{1}{\sqrt{3}} [ \begin{matrix}1 \\ 1 \\ - j\end{matrix} ] , \frac{1}{\sqrt{3}} [ \begin{matrix}1 \\ - 1 \\ j\end{matrix} ] , \frac{1}{\sqrt{3}} [ \begin{matrix}1 \\ - 1 \\ - j\end{matrix} ] , \frac{1}{\sqrt{3}} [ \begin{matrix}1 \\ j \\ 1\end{matrix} ] , \frac{1}{\sqrt{3}} [ \begin{matrix}1 \\ j \\ - 1\end{matrix} ] , \frac{1}{\sqrt{3}} [ \begin{matrix}1 \\ - j \\ 1\end{matrix} ] , \frac{1}{\sqrt{3}} [ \begin{matrix}1 \\ - j \\ - 1\end{matrix} ] .$$

In some embodiments, in the third vector, one element is 1, one element is a QPSK element and one element is 0. Specifically, the third vector is [1; 0; x]^{T}, or [1; x; 0]^{T}, or [0; 1; x]^{T}, where, x is from the set {1, −1, j, −j}.

In some embodiments, the third vector is at least one vector of the following vector set:

$$\frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ - j \\ 0\end{matrix} ] , \frac{1}{\sqrt{3}} [ \begin{matrix}1 \\ 0 \\ 1\end{matrix} ] , \frac{1}{\sqrt{3}} [ \begin{matrix}1 \\ 0 \\ - 1\end{matrix} ] , \frac{1}{\sqrt{3}} [ \begin{matrix}1 \\ 0 \\ j\end{matrix} ] , \frac{1}{\sqrt{3}} [ \begin{matrix}1 \\ 0 \\ - j\end{matrix} ] .$$

It should be noted that, in the third vector, 1/\sqrt{3} is the power normalization factor, which in practical application may be replaced with other values such as 1, or 1/\sqrt{5}, or 1/\sqrt{2}, or 1/\sqrt{6}, if the power normalization operation is not performed during the precoding process.

Specifically, for example, the third vector may include all the following 4 vectors:

$$\frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ j \\ 0\end{matrix} ] , \frac{1}{\sqrt{3}} [ \begin{matrix}1 \\ - j \\ 0\end{matrix} ] .$$

In some embodiments, the fourth vector is at least one vector of the following vector set:

$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ] .$$

It should be noted that, in the fourth vector, 1/\sqrt{3} is the power normalization factor, which in practical application may be replaced with other values such as 1, or 1/\sqrt{5}, or 1/\sqrt{2}, or 1/\sqrt{6}, if the power normalization operation is not performed during the precoding process.

Specifically, for example, the fourth vector may include all the following 3 vectors:

$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ] .$$

In some embodiments, the vectors included in the codebook are determined by a type of codebook configured by the network device.

Specifically, for example, in a case where the type of the codebook is a coherent codebook, the codebook includes the first vector, the third vector, and the fourth vector, or, the codebook includes the second vector, the third vector, and the fourth vector.

Specifically, for another example, in a case where the type of the codebook is a partial coherent codebook, the codebook includes the third vector and the fourth vector.

Specifically, for yet another example, in a case where the type of the codebook is a non-coherent codebook, the codebook includes the fourth vector.

In some embodiments, in a case where the number of the transport layers indicated by the TRI is 2, the codebook includes at least one of the following precoding matrices: a first precoding matrix, a second precoding matrix, a third precoding matrix, a fourth precoding matrix and a fifth precoding matrix.

In some embodiments, each column of the first precoding matrix is a constant-modulus DFT vector. Each non-zero element of the second precoding matrix is a constant-modulus QPSK element. The first column of the third precoding matrix consists of constant-modulus QPSK elements, the second column of the third precoding matrix consists of constant-modulus non-QPSK elements, and the second column vector of the third precoding matrix is orthogonal to the first column vector of the third precoding matrix. A first column of the fourth precoding matrix includes two QPSK elements, a second column of the fourth precoding matrix includes one QPSK element, these three QPSK elements are in different rows, and the other elements are 0. Each of the two columns of the fifth precoding matrix includes one element whose value is 1, these two elements are in different rows, and the other elements are all 0.

In some embodiments, each column of the first precoding matrix is a constant-modulus (i.e., the modulus of each element of that column is the same) 3-DFT vector. Specifically, the two column vectors of the first precoding matrix are two vectors of the 3O vectors. The 3O vectors are obtained by performing O times of oversampling on the DFT vector with a length of 3. O is a positive integer.

In some embodiments, the first precoding matrix is at least one of the following precoding matrices set:

$${W}_{m}^{( 2 )} = \frac{1}{\sqrt{6}} [ \begin{matrix}1 & 1 \\ {e}^{j \frac{2 π m}{3 O}} & {e}^{j ( \frac{2 π m}{3 O} + \frac{2 π}{3} )} \\ {e}^{j \frac{4 π m}{3 O}} & {e}^{j ( \frac{4 π m}{3 O} + \frac{4 π}{3} )}\end{matrix} ] ,$$

wherein, O is a positive integer.
m=0, 1, . . . 3O−1

It should be noted that, in the first precoding matrix, 1/\sqrt{6} is the power normalization factor, which in practical application may be replaced with other values such as 1, or 1/\sqrt{5}, or 1/\sqrt{2}, or 1/\sqrt{3}, if the power normalization operation is not performed during the precoding process.

In some embodiments, O=1, or O=3, or O=5.

For example, when O=1, the first precoding matrix includes all the 3 matrices of the above-mentioned precoding matrices set. For another example, when O=3, the first precoding matrix includes 4 or 8 matrices of the above-mentioned precoding matrices set.

In some embodiments, the elements of the first row of the second precoding matrix are all 1, other elements are QPSK elements, and the two column vectors are not identical and not orthogonal. In some embodiments of the present disclosure, the second precoding matrix includes a plurality of precoding matrices in which the elements of the first two rows are the same and the elements of the third row are different. The second precoding matrix is at least one of the following precoding matrices set:

$$\frac{1}{\sqrt{6}} [ \begin{matrix}1 & 1 \\ 1 & - 1 \\ 1 & j\end{matrix} ] , \frac{1}{\sqrt{6}} [ \begin{matrix}1 & 1 \\ 1 & - 1 \\ 1 & - j\end{matrix} ] , \frac{1}{\sqrt{6}} [ \begin{matrix}1 & 1 \\ 1 & - 1 \\ - 1 & j\end{matrix} ] , \frac{1}{\sqrt{6}} [ \begin{matrix}1 & 1 \\ 1 & - 1 \\ - 1 & - j\end{matrix} ] .$$

It should be noted that, in the second precoding matrix, 1/\sqrt{6} is the power normalization factor, which in practical application may be replaced with other values such as 1, or 1/\sqrt{5}, or 1/\sqrt{2}, or 1/\sqrt{3}, if the power normalization operation is not performed during the precoding process.

Specifically, for example, the second precoding matrix includes all 4 of the above-mentioned precoding matrices. The first two rows of the 4 precoding matrices are identical, but the third rows of the 4 precoding matrices are different from each other.

In some embodiments, the two column vectors of the second precoding matrix are orthogonal. One of the elements of the second column vector is 0 and all other elements are non-zero. For example, a form of the second precoding matrix may be

$$\frac{1}{\sqrt{5}} [ \begin{matrix}1 & 1 \\ x & 0 \\ y & z\end{matrix} ] or \frac{1}{\sqrt{5}} [ \begin{matrix}1 & 1 \\ x & z \\ y & 0\end{matrix} ] ,$$

where x, y and z are all from the set {1, −1, j, −j}. The second precoding matrix is at least one of the following precoding matrices set:

$$\frac{1}{\sqrt{5}} [ \begin{matrix}1 & 1 \\ 1 & 0 \\ 1 & - 1\end{matrix} ] , \frac{1}{\sqrt{5}} [ \begin{matrix}1 & 1 \\ 1 & 0 \\ - 1 & 1\end{matrix} ] , \frac{1}{\sqrt{5}} [ \begin{matrix}1 & 1 \\ 1 & 0 \\ j & - j\end{matrix} ] , \frac{1}{\sqrt{5}} [ \begin{matrix}1 & 1 \\ 1 & 0 \\ - j & j\end{matrix} ] , \frac{1}{\sqrt{5}} [ \begin{matrix}1 & 1 \\ - 1 & 0 \\ 1 & - 1\end{matrix} ] , \frac{1}{\sqrt{5}} [ \begin{matrix}1 & 1 \\ - 1 & 0 \\ - 1 & 1\end{matrix} ] , \frac{1}{\sqrt{5}} [ \begin{matrix}1 & 1 \\ - 1 & 0 \\ j & - j\end{matrix} ] , \frac{1}{\sqrt{5}} [ \begin{matrix}1 & 1 \\ - 1 & 0 \\ - j & j\end{matrix} ] , \frac{1}{\sqrt{5}} [ \begin{matrix}1 & 1 \\ j & 0 \\ 1 & - 1\end{matrix} ] , \frac{1}{\sqrt{5}} [ \begin{matrix}1 & 1 \\ j & 0 \\ - 1 & 1\end{matrix} ] , \frac{1}{\sqrt{5}} [ \begin{matrix}1 & 1 \\ j & 0 \\ j & j\end{matrix} ] , \frac{1}{\sqrt{5}} [ \begin{matrix}1 & 1 \\ j & 0 \\ - j & j\end{matrix} ] , \frac{1}{\sqrt{5}} [ \begin{matrix}1 & 1 \\ - j & 0 \\ 1 & - 1\end{matrix} ] , \frac{1}{\sqrt{5}} [ \begin{matrix}1 & 1 \\ - j & 0 \\ - 1 & 1\end{matrix} ] , \frac{1}{\sqrt{5}} [ \begin{matrix}1 & 1 \\ - j & 0 \\ j & - j\end{matrix} ] , \frac{1}{\sqrt{5}} [ \begin{matrix}1 & 1 \\ - j & 0 \\ - j & j\end{matrix} ] .$$

Specifically, for example, the second precoding matrix may include 4 or 8 precoding matrices of the above-mentioned matrices.

It should be noted that, in the second precoding matrix, 1/\sqrt{5} is a power normalization factor, and the power normalization factor may also be replaced with 1/\sqrt{6}, or 1/\sqrt{6}, or 1/\sqrt{2}. In practical application, if the power normalization operation is not performed during the precoding process, the power normalization factor may also be replaced with other values, such as 1.

In some embodiments, the third precoding matrix is at least one of the following precoding matrices set:

$$\frac{1}{\sqrt{6}} [ \begin{matrix}1 & 1 \\ 1 & - \frac{1}{2} + \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ - 1 & \frac{1}{2} + \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ 1 & - \frac{1}{2} + \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ - 1 & \frac{1}{2} + \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ j & - \frac{\sqrt{3}}{2} - \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ j & \frac{\sqrt{3}}{2} - \frac{1}{2} j \\ j & \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ - j & - \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ - j & \frac{\sqrt{3}}{2} + \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ - j & - \frac{\sqrt{3}}{2} + \frac{1}{2} j \\ j & \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ - j & - \frac{\sqrt{3}}{2} + \frac{1}{2} j\end{matrix} ] .$$

It should be noted that, in the third precoding matrix, 1/\sqrt{6} is the power normalization factor, which in practical application may be replaced with other values such as 1, or 1/\sqrt{5}, or 1/\sqrt{2}, or 1/\sqrt{3}, if the power normalization operation is not performed during the precoding process.

In some embodiments, one element in each of the first column and the second column of the fourth precoding matrix is 1.

In some embodiments, the fourth precoding matrix is at least one of the following precoding matrices set:

$$\frac{1}{\sqrt{3}} [ \begin{matrix}1 & 0 \\ 1 & 0 \\ 0 & 1\end{matrix} ] , \frac{1}{\sqrt{3}} [ \begin{matrix}1 & 0 \\ - 1 & 0 \\ 0 & 1\end{matrix} ] , \frac{1}{\sqrt{3}} [ \begin{matrix}1 & 0 \\ j & 0 \\ 0 & 1\end{matrix} ] , \frac{1}{\sqrt{3}} [ \begin{matrix}1 & 0 \\ - j & 0 \\ 0 & 1\end{matrix} ] , \frac{1}{\sqrt{3}} [ \begin{matrix}1 & 0 \\ 0 & 1 \\ 1 & 0\end{matrix} ] , \frac{1}{\sqrt{3}} [ \begin{matrix}1 & 0 \\ 0 & 1 \\ - 1 & 0\end{matrix} ] , \frac{1}{\sqrt{3}} [ \begin{matrix}1 & 0 \\ 0 & 1 \\ j & 0\end{matrix} ] , \frac{1}{\sqrt{3}} [ \begin{matrix}1 & 0 \\ 0 & 1 \\ - j & 0\end{matrix} ] , \frac{1}{\sqrt{3}} [ \begin{matrix}0 & 1 \\ 1 & 0 \\ 1 & 0\end{matrix} ] , \frac{1}{\sqrt{3}} [ \begin{matrix}0 & 1 \\ 1 & 0 \\ - 1 & 0\end{matrix} ] , \frac{1}{\sqrt{3}} [ \begin{matrix}0 & 1 \\ 1 & 0 \\ j & 0\end{matrix} ] , \frac{1}{\sqrt{3}} [ \begin{matrix}0 & 1 \\ 1 & 0 \\ - j & 0\end{matrix} ] .$$

It should be noted that, in the fourth precoding matrix, 1/\sqrt{3} is a power normalization factor, and the power normalization factor may also be replaced with 1/\sqrt{6}, or 1/\sqrt{5}, or 1/\sqrt{2}. In practical application, if the power normalization operation is not performed during the precoding process, the power normalization factor may also be replaced with other values, such as 1.

Specifically, for example, the fourth precoding matrix includes the 1^{st} to the 4^{th} matrices, or the 5^{th} to the 8^{th} matrices, or the 9^{th} to the 12^{th} matrices of the above-mentioned precoding matrices.

In some embodiments, the fifth precoding matrix includes at least one of the following precoding matrices set:

$$\frac{1}{\sqrt{3}} [ \begin{matrix}1 & 0 \\ 0 & 1 \\ 0 & 0\end{matrix} ] , \frac{1}{\sqrt{3}} [ \begin{matrix}1 & 0 \\ 0 & 0 \\ 0 & 1\end{matrix} ] , \frac{1}{\sqrt{3}} [ \begin{matrix}0 & 0 \\ 1 & 0 \\ 0 & 1\end{matrix} ] .$$

It should be noted that, in the fifth precoding matrix, 1/\sqrt{3} is a power normalization factor, and the power normalization factor may also be replaced with 1/\sqrt{6}, or 1/\sqrt{5}, or 1/\sqrt{2}. In practical application, if the power normalization operation is not performed during the precoding process, the power normalization factor may also be replaced with other values, such as 1.

Specifically, for example, the fifth precoding matrix may include all three of the above-mentioned precoding matrices.

In some embodiments, the precoding matrices included in the codebook are determined by the type of the codebook configured by the network device.

Specifically, for example, in a case where the type of the codebook is the coherent codebook, the codebook includes the first precoding matrix, the fourth precoding matrix and the fifth precoding matrix. Alternatively, the codebook includes the second precoding matrix, the fourth precoding matrix and the fifth precoding matrix. Alternatively, the codebook includes the third precoding matrix, the fourth precoding matrix and the fifth precoding matrix.

Specifically, for yet another example, in a case where the type of the codebook is the partial coherent codebook, the codebook includes the fourth precoding matrix and the fifth precoding matrix.

Specifically, for yet another example, in a case where the type of the codebook is the non-coherent codebook, the codebook includes the fifth precoding matrix.

In some embodiments, two layers of codewords may be generated based on the constant-modulus 3-DFT vectors. Alternatively, a two-layer codeword may be generated based on the constant-modulus QPSK elements. For example, the two layer vectors are not orthogonal.

In some embodiments, the first layer vector of a single layer or a double layers is generated by using constant-modulus QPSK elements. The second layer vector is generated by using non-QPSK elements and is orthogonal to the first layer vector.

In some embodiments, the codeword is generated based on constant-modulus QPSK elements. The two layer vectors are orthogonal to each other, and the second layer vector is transmitted only by 2 ports.

In some embodiments, in a case where the number of the transport layers indicated by the TRI is 3, an identity matrix of size 3 is included in the codebook.

For example, when a rank indicated by the TRI is 3, the codebook is:

$$\frac{1}{\sqrt{3}} [ \begin{matrix}1 & 0 & 0 \\ 0 & 1 & 0 \\ 0 & 0 & 1\end{matrix} ] .$$

It should be noted that, in the identity matrix, 1/\sqrt{3} is a power normalization factor, and the power normalization factor may also be replaced with 1/\sqrt{6}, or 1/\sqrt{5}, or 1/\sqrt{2}. In practical application, if the power normalization operation is not performed during the precoding process, the power normalization factor may also be replaced with other values, such as 1.

In some embodiments, the network device may receive the SRS configured for the uplink codebook transmission and transmitted by the terminal device. In the above-mentioned operation at block S310, the network device may determine the precoding matrix from the codebook according to the SRS. In other words, before the operation at block S310, the network device may receive the SRS configured for the uplink codebook transmission and transmitted by the terminal device.

In some embodiments, the SRS is an SRS for 3 antenna ports. In other words, the SRS resource of the SRS is configured with 3 antenna ports. The usage of the SRS resource is configured as a codebook.

In some embodiments, the network device may receive the data that is transmitted by the terminal device and has undergone the precoding process by using the precoding matrix.

Therefore, the codebook designed in embodiments of the present disclosure may support the uplink transmissions based on 3 antenna ports. As compared to the way of degrading the 3 antenna terminals into 2-port transmission, the antenna gains of the 3-antenna transmission may be fully utilized, and the spectral efficiency may be effectively increased. At the same time, as compared to the approach that may only support up to two layers of transmission, the codebook designed in embodiments of the present disclosure may support 3 layers of uplink transmission, thereby increasing the peak rate.

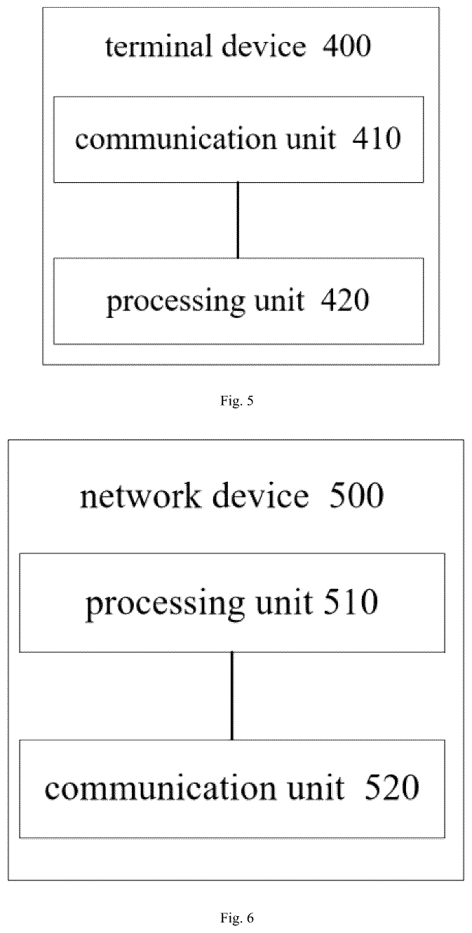

Method embodiments of the present disclosure are described in detail above in conjunction with FIGS. 3 4. Apparatus embodiments of the present disclosure are described in detail below in conjunction with FIG. 5 to FIG. 9. It should be appreciated that, the apparatus embodiments and the method embodiments may be correspondent to each other, and similar descriptions may refer to the method embodiments.

FIG. 5 is a schematic block diagram of a terminal device 400 according to an embodiment of the present disclosure. As illustrated in FIG. 5, the terminal device 400 includes: a communication unit 410 and a processing unit 420.

The communication unit 410 is configured to receive the transmit precoding matrix indicator (TPMI) and the transmitted rank indicator (TRI) transmitted by the network device.

The processing unit 420 is configured to determine, based on the TPMI, the precoding matrix from the codebook corresponding to the TRI. Each codeword in the codebook includes 3 rows.

The processing unit 420 is further configured to use the precoding matrix to perform the precoding process of the data.

The communication unit 410 is further configured to transmit the data that has been precoded.

In some embodiments, in a case where the number of the transport layers indicated by the TRI is 1, the codebook includes at least one of the following vectors: a first vector, a second vector, a third vector, and a fourth vector.

The first vector is a constant-modulus 3-Discrete Fourier Transform (DFT) vector. The three elements of the second vector are all constant-modulus Quadrature Phase Shift Keying (QPSK) elements. In the third vector, one element is 1, one element is a QPSK element and one element is 0. In the fourth vector, one element is 1, the other two elements are 0.

In some embodiments, the first vector is at least one of the 3O vectors. The 3O vectors are obtained by performing O times of oversampling on the DFT vector with a length of 3. O is a positive integer.

In some embodiments, the first vector is at least one vector of the following vector set:

$${W}_{m}^{( 1 )} = \frac{1}{\sqrt{3}} [ \begin{matrix}1 & {e}^{j \frac{2 π m}{3 O}} & {e}^{j \frac{4 π m}{3 O}}\end{matrix} ] ,$$

wherein, O is a positive integer.
m=0, 1, . . . 3O−1

In some embodiments, the first element of the second vector is 1.

In some embodiments, the second vector is at least one vector of the following vector set:

$$\frac{1}{\sqrt{3}} [ \begin{matrix}1 \\ 1 \\ j\end{matrix} ] , \frac{1}{\sqrt{3}} [ \begin{matrix}1 \\ 1 \\ - j\end{matrix} ] , \frac{1}{\sqrt{3}} [ \begin{matrix}1 \\ - 1 \\ j\end{matrix} ] , \frac{1}{\sqrt{3}} [ \begin{matrix}1 \\ - 1 \\ - j\end{matrix} ] , \frac{1}{\sqrt{3}} [ \begin{matrix}1 \\ j \\ 1\end{matrix} ] , \frac{1}{\sqrt{3}} [ \begin{matrix}1 \\ j \\ - 1\end{matrix} ] , \frac{1}{\sqrt{3}} [ \begin{matrix}1 \\ - j \\ 1\end{matrix} ] , \frac{1}{\sqrt{3}} [ \begin{matrix}1 \\ - j \\ - 1\end{matrix} ] .$$

In some embodiments, the third vector is at least one vector of the following vector set:

$$\frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ j \\ 0\end{matrix} ] , \frac{1}{\sqrt{3}} [ \begin{matrix}1 \\ - j \\ 0\end{matrix} ] , \frac{1}{\sqrt{3}} [ \begin{matrix}1 \\ 0 \\ 1\end{matrix} ] , \frac{1}{\sqrt{3}} [ \begin{matrix}1 \\ 0 \\ - 1\end{matrix} ] , \frac{1}{\sqrt{3}} [ \begin{matrix}1 \\ 0 \\ j\end{matrix} ] , \frac{1}{\sqrt{3}} [ \begin{matrix}1 \\ 0 \\ - j\end{matrix} ] .$$

In some embodiments, the fourth vector is at least one vector of the following vector set:

$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ] .$$

In some embodiments, the vectors included in the codebook are determined by the type of the codebook configured by the network device.

In some embodiments, in a case where the type of the codebook is the coherent codebook, the codebook includes the first vector, the third vector and the fourth vector. Alternatively, the codebook includes the second vector, the third vector and the fourth vector.

In some embodiments, in a case where the type of the codebook is the partial coherent codebook, the codebook includes the third vector and the fourth vector.

In some embodiments, in a case where the type of the codebook is the non-coherent codebook, the codebook includes the fourth vector.

In some embodiments, the power normalization factor of the vector includes at least one of the following: 1/\sqrt{3}, 1, 1/\sqrt{6}, 1/\sqrt{5}, 1/\sqrt{2}.

In some embodiments, in a case where the number of the transport layers indicated by the TRI is 2, the codebook includes at least one of the following precoding matrices: a first precoding matrix, a second precoding matrix, a third precoding matrix, a fourth precoding matrix and a fifth precoding matrix. Each column of the first precoding matrix is a constant-modulus DFT vector. Each non-zero element of the second precoding matrix is a constant-modulus QPSK element. The first column of the third precoding matrix consists of constant-modulus QPSK elements, the second column of the third precoding matrix consists of constant-modulus non-QPSK elements, and the second column vector of the third precoding matrix is orthogonal to the first column vector. A first column of the fourth precoding matrix includes two QPSK elements, a second column of the fourth precoding matrix includes one QPSK element, and these three QPSK elements are in different rows, and the other elements are 0. Each of the two columns of the fifth precoding matrix includes one element whose value is 1, these two elements are in different rows, and other elements are all 0.

In some embodiments, the two column vectors of the first precoding matrix are two vectors of the 3O vectors. The 3O vectors are obtained by performing O times of oversampling on the DFT vector with a length of 3. O is a positive integer.

In some embodiments, the first precoding matrix is at least one of the following precoding matrices set:

$${W}_{m}^{( 2 )} = \frac{1}{\sqrt{6}} [ \begin{matrix}1 & 1 \\ {e}^{j \frac{2 π m}{3 O}} & {e}^{j ( \frac{2 π m}{3 O} + \frac{2 π}{3} )} \\ {e}^{j \frac{4 π m}{3 O}} & {e}^{j ( \frac{4 π m}{3 O} + \frac{4 π}{3} )}\end{matrix} ] ,$$

wherein, O is a positive integer.
m=0, 1, . . . 3O−1

In some embodiments, the two column vectors of the second precoding matrix are orthogonal. One of the elements of the second column vector is 0 and all other elements are non-zero.

In some embodiments, the second precoding matrix is at least one of the following precoding matrices set:

$$\frac{1}{\sqrt{5}} [ \begin{matrix}1 & 1 \\ 1 & 0 \\ 1 & - 1\end{matrix} ] , \frac{1}{\sqrt{5}} [ \begin{matrix}1 & 1 \\ 1 & 0 \\ - 1 & 1\end{matrix} ] , \frac{1}{\sqrt{5}} [ \begin{matrix}1 & 1 \\ 1 & 0 \\ j & - j\end{matrix} ] , \frac{1}{\sqrt{5}} [ \begin{matrix}1 & 1 \\ 1 & 0 \\ - j & j\end{matrix} ] , \frac{1}{\sqrt{5}} [ \begin{matrix}1 & 1 \\ - 1 & 0 \\ 1 & - 1\end{matrix} ] , \frac{1}{\sqrt{5}} [ \begin{matrix}1 & 1 \\ - 1 & 0 \\ - 1 & 1\end{matrix} ] , \frac{1}{\sqrt{5}} [ \begin{matrix}1 & 1 \\ - 1 & 0 \\ j & - j\end{matrix} ] , \frac{1}{\sqrt{5}} [ \begin{matrix}1 & 1 \\ - 1 & 0 \\ - j & j\end{matrix} ] , \frac{1}{\sqrt{5}} [ \begin{matrix}1 & 1 \\ j & 0 \\ 1 & - 1\end{matrix} ] , \frac{1}{\sqrt{5}} [ \begin{matrix}1 & 1 \\ j & 0 \\ - 1 & 1\end{matrix} ] , \frac{1}{\sqrt{5}} [ \begin{matrix}1 & 1 \\ j & 0 \\ j & - j\end{matrix} ] , \frac{1}{\sqrt{5}} [ \begin{matrix}1 & 1 \\ j & 0 \\ - j & j\end{matrix} ] , \frac{1}{\sqrt{5}} [ \begin{matrix}1 & 1 \\ - j & 0 \\ 1 & - 1\end{matrix} ] , \frac{1}{\sqrt{5}} [ \begin{matrix}1 & 1 \\ - j & 0 \\ - 1 & 1\end{matrix} ] , \frac{1}{\sqrt{5}} [ \begin{matrix}1 & 1 \\ - j & 0 \\ j & - j\end{matrix} ] , \frac{1}{\sqrt{5}} [ \begin{matrix}1 & 1 \\ - j & 0 \\ - j & j\end{matrix} ] .$$

In some embodiments, the third precoding matrix is at least one of the following precoding matrices set:

$$\frac{1}{\sqrt{6}} [ \begin{matrix}1 & 1 \\ 1 & - \frac{1}{2} + \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ - 1 & \frac{1}{2} + \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ 1 & - \frac{1}{2} + \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ - 1 & \frac{1}{2} + \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ j & - \frac{\sqrt{3}}{2} - \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ j & \frac{\sqrt{3}}{2} - \frac{1}{2} j \\ j & \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ - j & - \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ - j & \frac{\sqrt{3}}{2} + \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ - j & - \frac{\sqrt{3}}{2} + \frac{1}{2} j \\ j & \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ - j & - \frac{\sqrt{3}}{2} + \frac{1}{2} j\end{matrix} ] .$$

In some embodiments, one element in each of the first column and the second column of the fourth precoding matrix is 1.

In some embodiments, the fourth precoding matrix is at least one of the following precoding matrices set:

$$\frac{1}{\sqrt{3}} [ \begin{matrix}1 & 0 \\ 1 & 0 \\ 1 & 1\end{matrix} ] , \frac{1}{\sqrt{3}} [ \begin{matrix}1 & 0 \\ - 1 & 0 \\ 1 & 1\end{matrix} ] , \frac{1}{\sqrt{3}} [ \begin{matrix}1 & 0 \\ j & 0 \\ 0 & 1\end{matrix} ] , \frac{1}{\sqrt{3}} [ \begin{matrix}1 & 0 \\ - j & 0 \\ 0 & 1\end{matrix} ] , \frac{1}{\sqrt{3}} [ \begin{matrix}1 & 0 \\ 0 & 1 \\ 1 & 0\end{matrix} ] , \frac{1}{\sqrt{3}} [ \begin{matrix}1 & 0 \\ 0 & 1 \\ - 1 & 0\end{matrix} ] , \frac{1}{\sqrt{3}} [ \begin{matrix}1 & 0 \\ 0 & 1 \\ j & 0\end{matrix} ] , \frac{1}{\sqrt{3}} [ \begin{matrix}1 & 0 \\ 0 & 1 \\ - j & 0\end{matrix} ] , \frac{1}{\sqrt{3}} [ \begin{matrix}0 & 1 \\ 1 & 0 \\ 1 & 0\end{matrix} ] , \frac{1}{\sqrt{3}} [ \begin{matrix}0 & 1 \\ 1 & 0 \\ - 1 & 0\end{matrix} ] , \frac{1}{\sqrt{3}} [ \begin{matrix}0 & 1 \\ 1 & 0 \\ j & 0\end{matrix} ] , \frac{1}{\sqrt{3}} [ \begin{matrix}0 & 1 \\ 1 & 0 \\ - j & 0\end{matrix} ] .$$

In some embodiments, the fifth precoding matrix is at least one of the following precoding matrices set:

$$\frac{1}{\sqrt{3}} [ \begin{matrix}1 & 0 \\ 0 & 1 \\ 0 & 0\end{matrix} ] , \frac{1}{\sqrt{3}} [ \begin{matrix}1 & 0 \\ 0 & 0 \\ 0 & 1\end{matrix} ] , \frac{1}{\sqrt{3}} [ \begin{matrix}0 & 0 \\ 1 & 0 \\ 0 & 1\end{matrix} ] .$$

In some embodiments, the precoding matrices included in the codebook are determined by the type of the codebook configured by the network device.

In some embodiments, in a case where the type of the codebook is the coherent codebook, the codebook includes the first precoding matrix, the fourth precoding matrix and the fifth precoding matrix. Alternatively, the codebook includes the second precoding matrix, the fourth precoding matrix and the fifth precoding matrix. Alternatively, the codebook includes the third precoding matrix, the fourth precoding matrix and the fifth precoding matrix.

In some embodiments, in a case where the type of the codebook is the partial coherent codebook, the codebook includes the fourth precoding matrix and the fifth precoding matrix.

In some embodiments, in a case where the type of the codebook is the non-coherent codebook, the codebook includes the fifth precoding matrix.

In some embodiments, the power normalization factor of the precoding matrix includes at least one of: 1/\sqrt{3}, 1, 1/\sqrt{6}, 1/\sqrt{5}, 1/\sqrt{2}.

In some embodiments, in a case where the number of the transport layers indicated by the TRI is 3, an identity matrix of size 3 is included in the codebook.

In some embodiments, the communication unit 410 is further configured to transmit the sounding reference signal (SRS) configured for the uplink codebook transmission. The SRS may be used by the network device to determine the TPMI.

In some embodiments, the SRS is an SRS for 3 antenna ports.

In some embodiments, the above-mentioned communication unit may be a communication interface or a transceiver, or an input/output interface of a communication chip or a system-on-chip. The above-mentioned processing unit may be one or more processors.

It should be appreciated that, the terminal device 400 according to embodiments of the present disclosure may correspond to the terminal device in the method embodiments of the present disclosure. The above-mentioned and other operations and/or functions of the various units of the terminal device 400 are intended to implement the corresponding processes of the terminal device in the method 200 illustrated in FIG. 3, respectively. For the sake of brevity, the details are not repeated here.

FIG. 6 is a schematic block diagram of a network device 500 according to an embodiment of the present disclosure.

As illustrated in FIG. 6, the network device 500 may include: a processing unit 510 and a communication unit 520.

The processing unit 510 is configured to determine the precoding matrix from the codebook corresponding to the transmitted rank indicator (TRI). Each codeword in the codebook includes 3 rows.

The communication unit 520 is configured to transmit the transmit precoding matrix indicator (TPMI) and the TRI corresponding to the precoding matrix to the terminal device. The TPMI is used by the terminal device to determine the precoding matrix from the codebook corresponding to the TRI.

In some embodiments, in a case where the number of the transport layers indicated by the TRI is 1, the codebook includes at least one of the following vectors: a first vector, a second vector, a third vector, and a fourth vector. The first vector is a constant-modulus 3-Discrete Fourier Transform (DFT) vector. The three elements of the second vector are all constant-modulus quadrature phase shift keying (QPSK) elements. In the third vector, one element is 1, one element is a QPSK element and one element is 0. In the fourth vector, one element is 1, the other two elements are 0.

In some embodiments, the first vector is at least one of the 3O vectors. The 3O vectors are obtained by performing O times of oversampling on the DFT vector with a length of 3. O is a positive integer.

In some embodiments, the first vector is at least one vector of the following vector set:

$${W}_{m}^{( 1 )} = \frac{1}{\sqrt{3}} [ \begin{matrix}1 & {e}^{j \frac{2 π m}{3 O}} & {e}^{j \frac{4 π m}{3 O}}\end{matrix} ] ,$$

wherein, O is a positive integer.
m=0, 1, . . . 3O−1

In some embodiments, the first element of the second vector is 1.

In some embodiments, the second vector is at least one vector of the following vector set:

$$\frac{1}{\sqrt{3}} [ \begin{matrix}1 \\ 1 \\ j\end{matrix} ] , \frac{1}{\sqrt{3}} [ \begin{matrix}1 \\ 1 \\ - j\end{matrix} ] , \frac{1}{\sqrt{3}} [ \begin{matrix}1 \\ - 1 \\ j\end{matrix} ] , \frac{1}{\sqrt{3}} [ \begin{matrix}1 \\ - 1 \\ - j\end{matrix} ] , \frac{1}{\sqrt{3}} [ \begin{matrix}1 \\ j \\ 1\end{matrix} ] , \frac{1}{\sqrt{3}} [ \begin{matrix}1 \\ j \\ - 1\end{matrix} ] , \frac{1}{\sqrt{3}} [ \begin{matrix}1 \\ - j \\ 1\end{matrix} ] , \frac{1}{\sqrt{3}} [ \begin{matrix}1 \\ - j \\ - 1\end{matrix} ] .$$

In some embodiments, the third vector is at least one vector of the following vector set:

$$\frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ j \\ 0\end{matrix} ] , \frac{1}{\sqrt{3}} [ \begin{matrix}1 \\ - j \\ 0\end{matrix} ] , \frac{1}{\sqrt{3}} [ \begin{matrix}1 \\ 0 \\ 1\end{matrix} ] , \frac{1}{\sqrt{3}} [ \begin{matrix}1 \\ 0 \\ - 1\end{matrix} ] , \frac{1}{\sqrt{3}} [ \begin{matrix}1 \\ 0 \\ j\end{matrix} ] \frac{1}{\sqrt{3}} [ \begin{matrix}1 \\ 0 \\ - j\end{matrix} ] .$$

In some embodiments, the fourth vector is at least one vector of the following vector set:

$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ] .$$

In some embodiments, the vectors included in the codebook are determined by a type of the codebook configured by the network device.

In some embodiments, in a case where the type of the codebook is the coherent codebook, the codebook includes the first vector, the third vector and the fourth vector. Alternatively, the codebook includes the second vector, the third vector and the fourth vector.

In some embodiments, in a case where the type of the codebook is the partial coherent codebook, the codebook includes the third vector and the fourth vector.

In some embodiments, in a case where the type of the codebook is the non-coherent codebook, the codebook includes the fourth vector.

In some embodiments, the power normalization factor of the vector includes at least one of: 1/\sqrt{3}, 1, 1/\sqrt{6}, 1/\sqrt{5}, 1/\sqrt{2}.

In some embodiments, in a case where the number of the transport layers indicated by the TRI is 2, the codebook includes at least one of the following precoding matrices: a first precoding matrix, a second precoding matrix, a third precoding matrix, a fourth precoding matrix and a fifth precoding matrix. Each column of the first precoding matrix is a constant-modulus DFT vector. Each non-zero element of the second precoding matrix is a constant-modulus QPSK element. The first column of the third precoding matrix consists of constant-modulus QPSK elements, the second column of the third precoding matrix consists of constant-modulus non-QPSK elements, and the second column vector of the third precoding matrix is orthogonal to the first column vector. A first column of the fourth precoding matrix includes two QPSK elements, a second column of the fourth precoding matrix includes one QPSK element, these three QPSK elements are in different rows, and the other elements are 0. Each of the two columns of the fifth precoding matrix includes one element with a value of 1, these two elements are in different rows, and the other elements are all 0.

In some embodiments, the two column vectors of the first precoding matrix are two vectors of the 3O vectors. The 3O vectors are obtained by performing O times of oversampling on the DFT vector with a length of 3. O is a positive integer.

In some embodiments, the first precoding matrix is at least one of the following precoding matrices set:

$${W}_{m}^{( 2 )} = \frac{1}{\sqrt{6}} [ \begin{matrix}1 & 1 \\ {e}^{j \frac{2 π m}{3 O}} & {e}^{j ( \frac{2 π m}{3 O} + \frac{2 π}{3} )} \\ {e}^{j \frac{4 π m}{3 O}} & {e}^{j ( \frac{4 π m}{3 O} + \frac{4 π}{3} )}\end{matrix} ] ,$$

wherein, O is a positive integer.
m=0, 1, . . . 3O−1

In some embodiments, the two column vectors of the second precoding matrix are orthogonal. One of the elements of the second column vector is 0 and all other elements are non-zero.

In some embodiments, the second precoding matrix is at least one of the following precoding matrices set:

$$\frac{1}{\sqrt{5}} [ \begin{matrix}1 & 1 \\ 1 & 0 \\ 1 & - 1\end{matrix} ] , \frac{1}{\sqrt{5}} [ \begin{matrix}1 & 1 \\ 1 & 0 \\ - 1 & 1\end{matrix} ] , \frac{1}{\sqrt{5}} [ \begin{matrix}1 & 1 \\ 1 & 0 \\ j & - j\end{matrix} ] , \frac{1}{\sqrt{5}} [ \begin{matrix}1 & 1 \\ 1 & 0 \\ - j & j\end{matrix} ] , \frac{1}{\sqrt{5}} [ \begin{matrix}1 & 1 \\ - 1 & 0 \\ 1 & - 1\end{matrix} ] , \frac{1}{\sqrt{5}} [ \begin{matrix}1 & 1 \\ - 1 & 0 \\ - 1 & 1\end{matrix} ] , \frac{1}{\sqrt{5}} [ \begin{matrix}1 & 1 \\ - 1 & 0 \\ j & - j\end{matrix} ] , \frac{1}{\sqrt{5}} [ \begin{matrix}1 & 1 \\ - 1 & 0 \\ - j & j\end{matrix} ] , \frac{1}{\sqrt{5}} [ \begin{matrix}1 & 1 \\ j & 0 \\ 1 & - 1\end{matrix} ] , \frac{1}{\sqrt{5}} [ \begin{matrix}1 & 1 \\ j & 0 \\ - 1 & 1\end{matrix} ] , \frac{1}{\sqrt{5}} [ \begin{matrix}1 & 1 \\ j & 0 \\ j & - j\end{matrix} ] , \frac{1}{\sqrt{5}} [ \begin{matrix}1 & 1 \\ j & 0 \\ - j & j\end{matrix} ] , \frac{1}{\sqrt{5}} [ \begin{matrix}1 & 1 \\ - j & 0 \\ 1 & - 1\end{matrix} ] , \frac{1}{\sqrt{5}} [ \begin{matrix}1 & 1 \\ - j & 0 \\ - 1 & 1\end{matrix} ] , \frac{1}{\sqrt{5}} [ \begin{matrix}1 & 1 \\ - j & 0 \\ j & - j\end{matrix} ] , \frac{1}{\sqrt{5}} [ \begin{matrix}1 & 1 \\ - j & 0 \\ - j & j\end{matrix} ] .$$

In some embodiments, the third precoding matrix is at least one of the following precoding matrices set:

$$\frac{1}{\sqrt{6}} [ \begin{matrix}1 & 1 \\ 1 & - \frac{1}{2} + \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ - 1 & \frac{1}{2} + \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ 1 & - \frac{1}{2} + \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ - 1 & \frac{1}{2} + \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ j & - \frac{\sqrt{3}}{2} - \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ j & \frac{\sqrt{3}}{2} - \frac{1}{2} j \\ j & \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ - j & - \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ - j & \frac{\sqrt{3}}{2} + \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ - j & - \frac{\sqrt{3}}{2} + \frac{1}{2} j \\ j & \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ - j & - \frac{\sqrt{3}}{2} + \frac{1}{2} j\end{matrix} ] .$$

In some embodiments, one element in each of the first column and the second column of the fourth precoding matrix is 1.

In some embodiments, the fourth precoding matrix is at least one of the following precoding matrices set:

$$\frac{1}{\sqrt{3}} [ \begin{matrix}1 & 0 \\ 1 & 0 \\ 0 & 1\end{matrix} ] , \frac{1}{\sqrt{3}} [ \begin{matrix}1 & 0 \\ - 1 & 0 \\ 0 & 1\end{matrix} ] , \frac{1}{\sqrt{3}} [ \begin{matrix}1 & 0 \\ j & 0 \\ 0 & 1\end{matrix} ] , \frac{1}{\sqrt{3}} [ \begin{matrix}1 & 0 \\ - j & 0 \\ 0 & 1\end{matrix} ] , \frac{1}{\sqrt{3}} [ \begin{matrix}1 & 0 \\ 0 & 1 \\ 1 & 0\end{matrix} ] , \frac{1}{\sqrt{3}} [ \begin{matrix}1 & 0 \\ 0 & 1 \\ - 1 & 0\end{matrix} ] , \frac{1}{\sqrt{3}} [ \begin{matrix}1 & 0 \\ 0 & 1 \\ j & 0\end{matrix} ] , \frac{1}{\sqrt{3}} [ \begin{matrix}1 & 0 \\ 0 & 1 \\ - j & 0\end{matrix} ] , \frac{1}{\sqrt{3}} [ \begin{matrix}0 & 1 \\ 1 & 0 \\ 1 & 0\end{matrix} ] , \frac{1}{\sqrt{3}} [ \begin{matrix}0 & 1 \\ 1 & 0 \\ - 1 & 0\end{matrix} ] , \frac{1}{\sqrt{3}} [ \begin{matrix}0 & 1 \\ 1 & 0 \\ j & 0\end{matrix} ] , \frac{1}{\sqrt{3}} [ \begin{matrix}0 & 1 \\ 1 & 0 \\ - j & 0\end{matrix} ] .$$

In some embodiments, the fifth precoding matrix is at least one of the following precoding matrices set:

$$\frac{1}{\sqrt{3}} [ \begin{matrix}1 & 0 \\ 0 & 1 \\ 0 & 0\end{matrix} ] , \frac{1}{\sqrt{3}} [ \begin{matrix}1 & 0 \\ 0 & 0 \\ 0 & 1\end{matrix} ] , \frac{1}{\sqrt{3}} [ \begin{matrix}0 & 0 \\ 1 & 0 \\ 0 & 1\end{matrix} ] .$$

In some embodiments, the precoding matrices included in the codebook are determined by the type of the codebook configured by the network device.

In some embodiments, in a case where the type of the codebook is the coherent codebook, the codebook includes the first precoding matrix, the fourth precoding matrix and the fifth precoding matrix. Alternatively, the codebook includes the second precoding matrix, the fourth precoding matrix and the fifth precoding matrix. Alternatively, the codebook includes the third precoding matrix, the fourth precoding matrix and the fifth precoding matrix.

In some embodiments, in a case where the type of the codebook is the partial coherent codebook, the codebook includes the fourth precoding matrix and the fifth precoding matrix.

In some embodiments, in a case where the type of the codebook is the non-coherent codebook, the codebook includes the fifth precoding matrix.

In some embodiments, the power normalization factor of the vector includes at least one of: 1/\sqrt{3}, 1, 1/\sqrt{6}, 1/\sqrt{5}, 1/\sqrt{2}.

In some embodiments, in a case where the number of the transport layers indicated by the TRI is 3, an identity matrix of size 3 is included in the codebook.

In some embodiments, the communication unit 520 is further configured to receive the sounding reference signal (SRS) configured for the uplink codebook transmission and transmitted by the terminal device.

The processing unit 510 is further configured to determine the precoding matrix from the codebook according to the SRS.

In some embodiments, the SRS is an SRS for 3 antenna ports.

In some embodiments, the communication unit 520 is further configured to receive the data that is transmitted by the terminal device and has undergone the precoding process by using the precoding matrix.

In some embodiments, the above-mentioned communication unit may be a communication interface or a transceiver, or an input/output interface of a communication chip or a system-on-chip. The above-mentioned processing unit may be one or more processors.

It should be appreciated that, the network device 500 according to embodiments of the present disclosure may correspond to the network device in the method embodiments of the present disclosure. The above-mentioned and other operations and/or functions of the various units of the network device 500 are intended to implement the corresponding processes of the network device in the method 300 illustrated in FIG. 4, respectively. For the sake of brevity, the details are not repeated here.

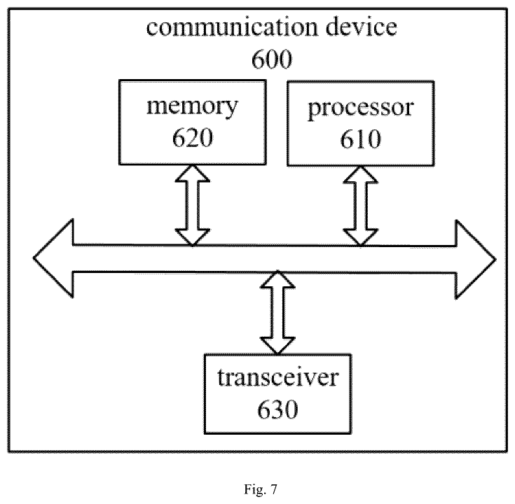

FIG. 7 is a schematic structural diagram of a communication device 600 provided according to an embodiment of the present disclosure. The communication device 600 illustrated in FIG. 7 includes a processor 610. The processor 610 may call and execute a computer program from the memory to implement the method in the embodiments of the present disclosure.

In some embodiments, as illustrated in FIG. 7, the communication device 600 may further include a memory 620. The processors 610 may call and execute the computer program from the memory 620 to implement the methods in the embodiments of the present disclosure.

The memory 620 may be a component separate from the processor 610 or may be integrated in the processor 610.

In some embodiments, as illustrated in FIG. 7, the communication device 600 may further include a transceiver 630. The processor 610 may control the transceiver 630 to communicate with other devices, specifically, to send information or data to, or receive information or data from, other devices.

The transceiver 630 may include a transmitter and a receiver. The transceiver 630 may further include an antenna. The number of the antenna may be one or more.

In some embodiments, the communication device 600 may specifically be the network device in some embodiments of the present disclosure, and the communication device 600 may implement the corresponding processes implemented by the network device in various methods of embodiments of the present disclosure. For the sake of brevity, the details are not repeated here.

In some embodiments, the communication device 600 may specifically be the terminal device in some embodiments of the present disclosure, and the communication device 600 may implement the corresponding processes implemented by the terminal device in various methods of embodiments of the present disclosure. For the sake of brevity, the details are not repeated here.

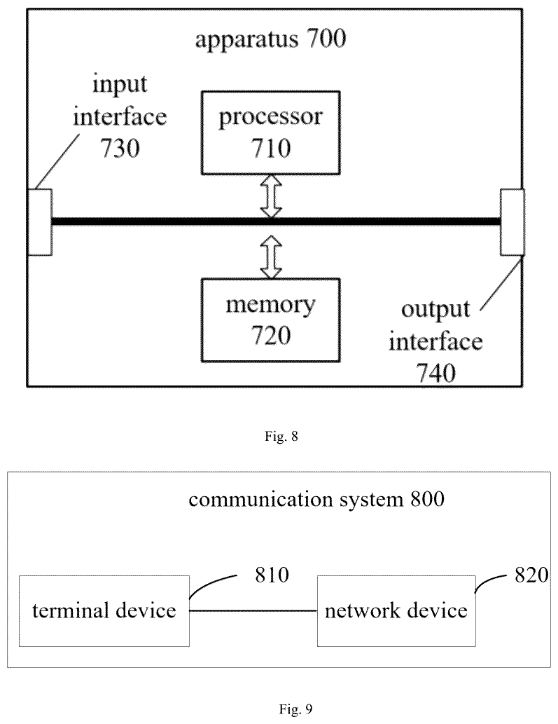

FIG. 8 is a schematic structural diagram of an apparatus according to an embodiment of the present disclosure. The apparatus 700 illustrated in FIG. 8 includes a processor 710. The processor 710 may call and execute a computer program from the memory to implement the method in the embodiments of the present disclosure.

In some embodiments, as illustrated in FIG. 8, the apparatus 700 may further include a memory 720. The processors 710 may call and execute the computer program from the memory 720 to implement the methods in the embodiments of the present disclosure.

The memory 720 may be a component separate from the processor 710 or may be integrated in the processor 710.

In some embodiments, the apparatus 700 may further include an input interface 730. The processor 710 may control the input interface 730 to communicate with other devices or chips, specifically, to obtain information or data sent from other devices or chips.

In some embodiments, the apparatus 700 may further include an output interface 740. The processor 710 may control the output interface 740 to communicate with other devices or chips, specifically, to output information or data to other devices or chips.

In some embodiments, the apparatus may be applied to the network device in embodiments of the present disclosure, and the apparatus may implement the corresponding processes implemented by the network device in various methods of embodiments of the present disclosure. For the sake of brevity, the details are not repeated here.

In some embodiments, the apparatus may be applied to the terminal device in embodiments of the present disclosure, and the apparatus may implement the corresponding processes implemented by the terminal device in various methods of embodiments of the present disclosure. For the sake of brevity, the details are not repeated here.

In some embodiments, the apparatus mentioned in embodiments of the present disclosure may be a chip. The chip may also be referred to as a system-on-chip, system-on-a-chip, System on Chip or SOC etc.

FIG. 9 is a schematic block diagram of a communication system 800 according to an embodiment of the present disclosure. As illustrated in FIG. 9, the communication system 800 includes the terminal device 810 and the network device 820.

In some embodiments, the terminal device 810 may be configured to implement the corresponding function of the above-mentioned method that is implemented by the terminal device, and the network device 820 may be configured to implement the corresponding function of the above-mentioned method that is implemented by the network device. For the sake of brevity, the details are not repeated here.

It should be appreciated that, the processor of embodiments of the present disclosure may be a kind of integrated circuit chip, which is capable of processing signals. During implementation, each operation of the above-mentioned method embodiment may be accomplished by an integrated logic circuitry of a hardware of the processor or an instruction in software-form. The above-mentioned processor may be a general-purpose processor, a digital signal processor (DSP), an application specific integrated circuit (ASIC), a field programmable gate array (FPGA) or other programmable logic device, a discrete gate or a transistor logic device, a discrete hardware component. The processor may realize or implement various methods, steps or logical block diagrams disclosed in embodiments of the present disclosure. The general-purpose processor may be a micro-processor or the processor may also be any kind of conventional processor, etc. The steps of methods disclosed in conjunction with the embodiments of the present disclosure may be performed directly by the hardware decoding processor, or by a combination of hardware and software modules in the decoding processor. The software module may be in a random memory, a flash memory, a read-only memory, a programmable read-only memory or an electrically erasable and programmable memory, a register and other storage media proven in the field. The storage medium is in the memory. The processor may read the information in the memory and complete the steps of the above-mentioned method in combination with its hardware.

It should be appreciated that, the memory in some embodiments of the present disclosure may be a volatile memory or a non-volatile memory. The memory may include both the volatile memory and the non-volatile memory. The non-volatile memory may be a read-only memory (ROM), a programmable ROM (PROM), an erasable PROM (EPROM), an electrically EPROM (EEPROM) or a flash memory. The volatile memory may be a random access memory (RAM), which may be used as an external cache. By way of illustration but not limitation, many forms of RAMs are available, such as static RAMs (SRAM), dynamic RAMs (DRAM), synchronous DRAMs (SDRAM), double data rate SDRAMs (DDR SDRAM), enhanced SDRAMs (ESDRAM), synchlink DRAMs (SLDRAM), and direct rambus RAMs (DR RAM). It should be appreciated that, the memory of the systems and methods described herein is intended to include, but not limited to, these and any other suitable types of memories.

It should be appreciated that; the above-mentioned description of the memory is for illustration but not for limitation. For example, the memory in some embodiments of the present disclosure may further be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM) and a direct rambus RAM (DR RAM) etc. In other words, the memory described in embodiments of the present disclosure is intended to include, but is not limited to, these and any other suitable types of memories.

A computer-readable storage medium configured to store a computer program is provided in some embodiments of the present disclosure.

In some embodiments, the computer-readable storage medium may be applied to the network device in embodiments of the present disclosure, and the computer program enables the computer to implement the corresponding processes implemented by the network device in the various methods of embodiments of the present disclosure. For the sake of brevity, the details are not repeated here.

In some embodiments, the computer-readable storage medium may be applied to the terminal device in embodiments of the present disclosure, and the computer program enables the computer to implement the corresponding processes implemented by the terminal device in the various methods of embodiments of the present disclosure. For the sake of brevity, the details are not repeated here.

A computer program product including a computer program instruction is further provided according to some embodiments of the present disclosure.

In some embodiments, the computer program product may be applied to the network device in embodiments of the present disclosure, and the computer program instruction enables the computer to implement the corresponding processes implemented by the network device in various methods of embodiments of the present disclosure. For the sake of brevity, the details are not repeated here.

In some embodiments, the computer program product may be applied to the terminal device in embodiments of the present disclosure, and the computer program instruction enables the computer to implement the corresponding processes implemented by the terminal device in the various methods of embodiments of the present disclosure. For the sake of brevity, the details are not repeated here.

A computer program is provided according to embodiments of the present disclosure.

In some embodiments, the computer program may be applied to the network device in embodiments of the present disclosure, and the computer program, when running on the computer, enables the computer to implement the corresponding processes implemented by the network device in the various methods of embodiments of the present disclosure. For the sake of brevity, the details are not repeated here.

In some embodiments, the computer program may be applied to the terminal device in embodiments of the present disclosure, and the computer program, when running on the computer, enables the computer to implement the corresponding processes implemented by the terminal device in the various methods of embodiments of the present disclosure. For the sake of brevity, the details are not repeated here.

Those of ordinary skills in the art may realize that, the units and algorithmic steps of the various examples described in conjunction with the embodiments disclosed herein are capable of being implemented in electronic hardware, or a combination of computer software and electronic hardware. Whether these functions are performed in hardware or software depends on the specific application and design constraints of the technical schemes. For each particular application, a person skilled in the art may use different methods to implement the described functions, but such implementations should not be considered as beyond the scope of the present disclosure.

It is clear to those skilled in the art to which the present disclosure belongs that, for the sake of convenience and brevity, the specific operating processes of the above-described systems, apparatuses, and units may be referred to the corresponding processes in the foregoing method embodiments, and will not be elaborated herein.

In the embodiments provided in the present disclosure, it should be understood that, the disclosed system, apparatus and method may be embodied in other ways. For example, the apparatus embodiment described above is only schematic. For example, the division of the modules may just be a division of logical function. In actual implementations, there may be other divisions. For example, multiple units or components may be combined or integrated into another system. Or some features may be ignored or not implemented. In addition, the illustrated or discussed mutual coupling or direct coupling or communicating connection may be indirect coupling or communicating connection through some interfaces, apparatuses, or units, and may be electrical, mechanical or of other forms.

The units illustrated as separate components may or may not be physically separate, and the components illustrated as units may or may not be physical units. The units may be in one place or may be distributed on multiple network units. Some or all the units may be selected as per actual needs to fulfill the object of the implementation of the present embodiment.

In addition, each functional unit in embodiments of the present disclosure may be integrated into one processing unit, or may be physically separate units, or two or more units may be integrated into one unit.

If the function is implemented in the form of software functional units and sold or used as independent product, then they could be stored in a computer-readable storage medium. With this understanding in mind, the technical solutions of the embodiments of the present disclosure in essence or its parts that contribute to the art or part of the technical scheme may be embodied in the form of a software product. The computer software product may be stored in a storage medium and include several instructions to make a computer device (which may be a personal computer, a server, or a network device etc.) to execute all or parts of the steps of the method described in various embodiments of the present disclosure. The afore-mentioned storage medium may include: a U disk, a mobile hard disk drive, a read only memory (ROM), a random access memory (RAM), a magnetic disk or a CD-ROM and other media that can store program codes.

The above are only specific implementations of the present disclosure, and the protection scope of the present disclosure is not limited thereto. Changes or alternations within the technical scope of the present disclosure could easily occur to those skilled in the art and should be considered to be in the protection scope of the present disclosure. Therefore, the protection scope of the present disclosure should be subject to the appended claims.

What is claimed is:

1. A wireless communication method, comprising:
receiving, by a terminal device, a transmit precoding matrix indicator (TPMI) and a transmitted rank indicator (TRI) transmitted by a network device;
determining, by the terminal device based on the TPMI, a precoding matrix from a codebook corresponding to the TRI, wherein each codeword of the codebook comprises 3 rows;
performing, by the terminal device, a precoding process of data with the precoding matrix; and
transmitting, by the terminal device, data that has been precoded.

2. The method as claimed in claim 1, wherein
in response to the number of the transport layers indicated by the TRI being 1, the codebook comprising at least one of: a first vector, a second vector, a third vector, and a fourth vector; wherein the first vector is a constant-modulus 3-discrete Fourier transform (DFT) vector; three elements of the second vector are all constant-modulus quadrature phase shift keying (QPSK) elements; in the third vector, one element is 1, one element is a QPSK element and one element is 0; and in the fourth vector, one element is 1, the other two elements are 0; and/or
in response to the number of the transport layers indicated by the TRI being 2, the codebook comprises at least one of: a first precoding matrix, a second precoding matrix, a third precoding matrix, a fourth precoding matrix and a fifth precoding matrix; wherein each column of the first precoding matrix is a constant-modulus DFT vector; each non-zero element of the second precoding matrix is a constant-modulus QPSK element; a first column of the third precoding matrix consists of constant-modulus QPSK elements, a second column of the third precoding matrix consists of constant-modulus non-QPSK elements, and a second column vector of the third precoding matrix is orthogonal to a first column vector of the third precoding matrix; a first column of the fourth precoding matrix comprises two QPSK elements, a second column of the fourth precoding matrix comprises one QPSK element, the three QPSK elements are in different rows, and the other elements are 0; and each of two columns of the fifth precoding matrix comprises one element whose value is 1, the two elements are in different rows, and other elements are all 0; and/or
in response to the number of the transport layers indicated by the TRI being 3, the codebook comprises an identity matrix of size 3.

3. The method as claimed in claim 2, wherein
the first vector is at least one of 3O vectors, the 3O vectors are obtained by performing O times of oversampling on the DFT vector with a length of 3; and/or
the first vector is at least one vector of the following vector set:
$$\begin{matrix}{W}_{m}^{( 1 )} = {\frac{1}{\sqrt{3}} [ \begin{matrix}1 & {e}^{j \frac{2 π m}{3 O}} & {e}^{j \frac{4 π m}{3 O}}\end{matrix} ]}^{T} \\ m = 0 , 1 , … 3 O - 1\end{matrix}$$
wherein, O is a positive integer.

4. The method as claimed in claim 2, wherein
a first element of the second vector is 1; and/or
the second vector is at least one vector of the following vector set:
$$\frac{1}{\sqrt{3}} [ \begin{matrix}1 \\ 1 \\ j\end{matrix} ] , \frac{1}{\sqrt{3}} [ \begin{matrix}1 \\ 1 \\ - j\end{matrix} ] , \frac{1}{\sqrt{3}} [ \begin{matrix}1 \\ - 1 \\ j\end{matrix} ] , \frac{1}{\sqrt{3}} [ \begin{matrix}1 \\ - 1 \\ - j\end{matrix} ] , \frac{1}{\sqrt{3}} [ \begin{matrix}1 \\ j \\ 1\end{matrix} ] , \frac{1}{\sqrt{3}} [ \begin{matrix}1 \\ j \\ - 1\end{matrix} ] , \frac{1}{\sqrt{3}} [ \begin{matrix}1 \\ - j \\ 1\end{matrix} ] , \frac{1}{\sqrt{3}} [ \begin{matrix}1 \\ - j \\ - 1\end{matrix} ] .$$

5. The method as claimed in claim 2, wherein
the third vector is at least one vector of the following vector set:
$$\frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ j \\ 0\end{matrix} ] , \frac{1}{\sqrt{3}} [ \begin{matrix}1 \\ - j \\ 0\end{matrix} ] , \frac{1}{\sqrt{3}} [ \begin{matrix}1 \\ 0 \\ 1\end{matrix} ] , \frac{1}{\sqrt{3}} [ \begin{matrix}1 \\ 0 \\ - 1\end{matrix} ] , \frac{1}{\sqrt{3}} [ \begin{matrix}1 \\ 0 \\ j\end{matrix} ] , \frac{1}{\sqrt{3}} [ \begin{matrix}1 \\ 0 \\ - j\end{matrix} ] ;$$
and/or
the fourth vector is at least one vector of the following vector set:
$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ] .$$

6. A terminal device comprising a processor and a memory, wherein
the memory is configured to store a computer program,
the processor is configured to recall and run the computer program stored in the memory, and to implement a wireless communication method comprising:
receiving a transmit precoding matrix indicator (TPMI) and a transmitted rank indicator (TRI) transmitted by a network device;
determining, based on the TPMI, a precoding matrix from a codebook corresponding to the TRI, wherein each codeword of the codebook comprises 3 rows;
performing a precoding process of data with the precoding matrix; and
transmitting data that has been precoded.

7. The terminal device as claimed in claim 6, wherein
in response to the number of the transport layers indicated by the TRI being 1, the codebook comprises at least one of: a first vector, a second vector, a third vector, and a fourth vector, wherein the first vector is a constant-modulus 3-discrete Fourier transform (DFT) vector; three elements of the second vector are all constant-modulus quadrature phase shift keying (QPSK) elements; in the third vector, one element is 1, one element is a QPSK element and one element is 0; and in the fourth vector, one element is 1, the other two elements are 0; and/or
in response to the number of the transport layers indicated by the TRI being 2, the codebook comprises at least one of: a first precoding matrix, a second precoding matrix, a third precoding matrix, a fourth precoding matrix and a fifth precoding matrix; wherein each column of the first precoding matrix is a constant-modulus DFT vector; each non-zero element of the second precoding matrix is a constant-modulus QPSK element; a first column of the third precoding matrix consists of constant-modulus QPSK elements, a second column of the third precoding matrix consists of constant-modulus non-QPSK elements, and a second column vector of the third precoding matrix is orthogonal to a first column vector of the third precoding matrix; a first column of the fourth precoding matrix comprises two QPSK elements, a second column of the fourth precoding matrix comprises one QPSK element, the three QPSK elements are in different rows, and the other elements are 0; and each of two columns of the fifth precoding matrix comprises one element whose value is 1, the two elements are in different rows, and other elements are all 0; and/or
in response to the number of the transport layers indicated by the TRI being 3, the codebook comprises an identity matrix of size 3.

8. The terminal device as claimed in claim 7, wherein
the first vector is at least one of 3O vectors, the 3O vectors are obtained by performing O times of oversampling on the DFT vector with a length of 3; and/or
the first vector is at least one vector of the following vector set:
$$\begin{matrix}{W}_{m}^{( 1 )} = {\frac{1}{\sqrt{3}} [ \begin{matrix}1 & {e}^{j \frac{2 π m}{3 O}} & {e}^{j \frac{4 π m}{3 O}}\end{matrix} ]}^{T} \\ m = 0 , 1 , … 3 O - 1 ,\end{matrix}$$
wherein, O is a positive integer.

9. The terminal device as claimed in claim 7, wherein
a first element of the second vector is 1; and/or
the second vector is at least one vector of the following vector set:
$$\frac{1}{\sqrt{3}} [ \begin{matrix}1 \\ 1 \\ j\end{matrix} ] , \frac{1}{\sqrt{3}} [ \begin{matrix}1 \\ 1 \\ - j\end{matrix} ] , \frac{1}{\sqrt{3}} [ \begin{matrix}1 \\ - 1 \\ j\end{matrix} ] , \frac{1}{\sqrt{3}} [ \begin{matrix}1 \\ - 1 \\ - j\end{matrix} ] , \frac{1}{\sqrt{3}} [ \begin{matrix}1 \\ j \\ 1\end{matrix} ] , \frac{1}{\sqrt{3}} [ \begin{matrix}1 \\ j \\ - 1\end{matrix} ] , \frac{1}{\sqrt{3}} [ \begin{matrix}1 \\ - j \\ 1\end{matrix} ] , \frac{1}{\sqrt{3}} [ \begin{matrix}1 \\ - j \\ - 1\end{matrix} ] .$$

10. The terminal device as claimed in claim 7, wherein
the third vector is at least one vector of the following vector set:
$$\frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ j \\ 0\end{matrix} ] , \frac{1}{\sqrt{3}} [ \begin{matrix}1 \\ - j \\ 0\end{matrix} ] , \frac{1}{\sqrt{3}} [ \begin{matrix}1 \\ 0 \\ 1\end{matrix} ] , \frac{1}{\sqrt{3}} [ \begin{matrix}1 \\ 0 \\ - 1\end{matrix} ] , \frac{1}{\sqrt{3}} [ \begin{matrix}1 \\ 0 \\ j\end{matrix} ] , \frac{1}{\sqrt{3}} [ \begin{matrix}1 \\ 0 \\ - j\end{matrix} ] ;$$
and/or
the fourth vector is at least one vector of the following vector set:
$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ] .$$

11. The terminal device as claimed in claim 7, wherein
vectors comprised in the codebook are determined by a type of the codebook configured by the network device,
wherein in response to the type of the codebook being a coherent codebook: the codebook comprises the first vector, the third vector and the fourth vector; or the codebook comprises the second vector, the third vector and the fourth vector; and/or
in response to the type of the codebook being a partial coherent codebook, the codebook comprises the third vector and the fourth vector; and/or
in response to the type of the codebook being a non-coherent codebook, the codebook comprises the fourth vector.

12. The terminal device as claimed in claim 7, wherein
two column vectors of the first precoding matrix are two vectors of 3O vectors, the 3O vectors are obtained by performing O times of oversampling on the DFT vector with a length of 3; and/or
the first precoding matrix is at least one of the following precoding matrix set:
$$\begin{matrix}{W}_{m}^{( 2 )} = \frac{1}{\sqrt{6}} [ \begin{matrix}1 & 1 \\ {e}^{j \frac{2 π m}{3 O}} & {e}^{j ( \frac{2 π m}{3 O} + \frac{2 π}{3} )} \\ {e}^{j \frac{4 π m}{3 O}} & {e}^{j ( \frac{4 π m}{3 O} + \frac{4 π}{3} )}\end{matrix} ] , \\ m = 0 , 1 , … 3 O - 1\end{matrix}$$
wherein, O is a positive integer.

13. The terminal device as claimed in claim 7, wherein
two column vectors of the second precoding matrix are orthogonal, one of the elements of the second column vector is 0 and all other elements are non-zero; and/or
the second precoding matrix is at least one of the following precoding matrices set:
$$\frac{1}{\sqrt{5}} [ \begin{matrix}1 & 1 \\ 1 & 0 \\ 1 & - 1\end{matrix} ] , \frac{1}{\sqrt{5}} [ \begin{matrix}1 & 1 \\ 1 & 0 \\ - 1 & 1\end{matrix} ] , \frac{1}{\sqrt{5}} [ \begin{matrix}1 & 1 \\ 1 & 0 \\ j & - j\end{matrix} ] , \frac{1}{\sqrt{5}} [ \begin{matrix}1 & 1 \\ 1 & 0 \\ - j & j\end{matrix} ] , \frac{1}{\sqrt{5}} [ \begin{matrix}1 & 1 \\ - 1 & 0 \\ 1 & - 1\end{matrix} ] , \frac{1}{\sqrt{5}} [ \begin{matrix}1 & 1 \\ - 1 & 0 \\ - 1 & 1\end{matrix} ] , \frac{1}{\sqrt{5}} [ \begin{matrix}1 & 1 \\ - 1 & 0 \\ j & - j\end{matrix} ] , \frac{1}{\sqrt{5}} [ \begin{matrix}1 & 1 \\ - 1 & 0 \\ - j & j\end{matrix} ] , \frac{1}{\sqrt{5}} [ \begin{matrix}1 & 1 \\ j & 0 \\ 1 & - 1\end{matrix} ] , \frac{1}{\sqrt{5}} [ \begin{matrix}1 & 1 \\ j & 0 \\ - 1 & 1\end{matrix} ] , \frac{1}{\sqrt{5}} [ \begin{matrix}1 & 1 \\ j & 0 \\ j & - j\end{matrix} ] , \frac{1}{\sqrt{5}} [ \begin{matrix}1 & 1 \\ j & 0 \\ - j & j\end{matrix} ] , \frac{1}{\sqrt{5}} [ \begin{matrix}1 & 1 \\ - j & 0 \\ 1 & - 1\end{matrix} ] , \frac{1}{\sqrt{5}} [ \begin{matrix}1 & 1 \\ - j & 0 \\ - 1 & 1\end{matrix} ] , \frac{1}{\sqrt{5}} [ \begin{matrix}1 & 1 \\ - j & 0 \\ j & - j\end{matrix} ] , \frac{1}{\sqrt{5}} [ \begin{matrix}1 & 1 \\ - j & 0 \\ - j & j\end{matrix} ] .$$

14. The terminal device as claimed in claim 7, wherein
the third precoding matrix is at least one of the following precoding matrices set:
$$\frac{1}{\sqrt{6}} [ \begin{matrix}1 & 1 \\ 1 & - \frac{1}{2} + \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ - 1 & \frac{1}{2} + \frac{\sqrt{3}}{2} j\end{matrix} ] , \frac{1}{\sqrt{6}} [ \begin{matrix}1 & 1 \\ 1 & - \frac{1}{2} + \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ 1 & - \frac{1}{2} + \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ 1 & - \frac{1}{2} - \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ - 1 & \frac{1}{2} + \frac{\sqrt{3}}{2} j\end{matrix} ] , \frac{1}{\sqrt{6}} [ \begin{matrix}1 & 1 \\ - 1 & \frac{1}{2} - \frac{\sqrt{3}}{2} j \\ j & \frac{\sqrt{3}}{2} + \frac{1}{2} j\end{matrix} ] , \frac{1}{\sqrt{6}} [ \begin{matrix}1 & 1 \\ - 1 & \frac{1}{2} - \frac{\sqrt{3}}{2} j \\ - j & - \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ j & - \frac{\sqrt{3}}{2} - \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ j & \frac{\sqrt{3}}{2} - \frac{1}{2} j \\ j & \frac{\sqrt{3}}{2} + \frac{1}{2} j\end{matrix} ] , \frac{1}{\sqrt{6}} [ \begin{matrix}1 & 1 \\ j & - \frac{\sqrt{3}}{2} - \frac{1}{2} j \\ - j & - \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ 1 & - \frac{1}{2} - \frac{\sqrt{3}}{2} j\end{matrix} ] , \frac{1}{\sqrt{6}} [ \begin{matrix}1 & 1 \\ - j & \frac{\sqrt{3}}{2} + \frac{1}{2} j \\ - 1 & \frac{1}{2} + \frac{\sqrt{3}}{2} j\end{matrix} ] , \frac{1}{\sqrt{6}} [ \begin{matrix}1 & 1 \\ - j & - \frac{\sqrt{3}}{2} + \frac{1}{2} j \\ j & \frac{\sqrt{3}}{2} + \frac{1}{2} j\end{matrix} ] , \frac{1}{\sqrt{6}} [ \begin{matrix}1 & 1 \\ - j & \frac{\sqrt{3}}{2} + \frac{1}{2} j \\ - j & - \frac{\sqrt{3}}{2} + \frac{1}{2} j\end{matrix} ] ;$$
and/or
one element in each of the first column and the second column of the fourth precoding matrix is 1; and/or
the fourth precoding matrix is at least one of the following precoding matrices set:
$$\frac{1}{\sqrt{3}} [ \begin{matrix}1 & 0 \\ 1 & 0 \\ 0 & 1\end{matrix} ] , \frac{1}{\sqrt{3}} [ \begin{matrix}1 & 0 \\ - 1 & 0 \\ 0 & 1\end{matrix} ] , \frac{1}{\sqrt{3}} [ \begin{matrix}1 & 0 \\ j & 0 \\ 0 & 1\end{matrix} ] , \frac{1}{\sqrt{3}} [ \begin{matrix}1 & 0 \\ - j & 0 \\ 0 & 1\end{matrix} ] , \frac{1}{\sqrt{3}} [ \begin{matrix}1 & 0 \\ 0 & 1 \\ 1 & 0\end{matrix} ] , \frac{1}{\sqrt{3}} [ \begin{matrix}1 & 0 \\ 0 & 1 \\ - 1 & 0\end{matrix} ] , \frac{1}{\sqrt{3}} [ \begin{matrix}1 & 0 \\ 0 & 1 \\ j & 0\end{matrix} ] , \frac{1}{\sqrt{3}} [ \begin{matrix}1 & 0 \\ 0 & 1 \\ - j & 0\end{matrix} ] , \frac{1}{\sqrt{3}} [ \begin{matrix}0 & 1 \\ 1 & 0 \\ 1 & 0\end{matrix} ] , \frac{1}{\sqrt{3}} [ \begin{matrix}0 & 1 \\ 1 & 0 \\ - 1 & 0\end{matrix} ] , \frac{1}{\sqrt{3}} [ \begin{matrix}0 & 1 \\ 1 & 0 \\ j & 0\end{matrix} ] , \frac{1}{\sqrt{3}} [ \begin{matrix}0 & 1 \\ 1 & 0 \\ - j & 0\end{matrix} ] ; and / or$$
the fifth precoding matrix is at least one of the following precoding matrices set:
$$\frac{1}{\sqrt{3}} [ \begin{matrix}1 & 0 \\ 0 & 1 \\ 0 & 0\end{matrix} ] , \frac{1}{\sqrt{3}} [ \begin{matrix}1 & 0 \\ 0 & 0 \\ 0 & 1\end{matrix} ] , \frac{1}{\sqrt{3}} [ \begin{matrix}0 & 0 \\ 1 & 0 \\ 0 & 1\end{matrix} ] .$$

15. The terminal device as claimed in claim 7, wherein
precoding matrices included in the codebook are determined by a type of the codebook configured by the network device,
wherein, in response to the type of the codebook being a coherent codebook: the codebook comprises the first precoding matrix, the fourth precoding matrix and the fifth precoding matrix; or the codebook comprises the second precoding matrix, the fourth precoding matrix and the fifth precoding matrix; or the codebook comprises the third precoding matrix, the fourth precoding matrix and the fifth precoding matrix; and/or
in response to the type of the codebook being a partial coherent codebook, the codebook comprises the fourth precoding matrix and the fifth precoding matrix; and/or
in response to the type of the codebook being a non-coherent codebook, the codebook comprises the fifth precoding matrix.

16. A network device comprising a processor and a memory, wherein
the memory is configured to store a computer program,
the processor is configured to recall and run the computer program stored in the memory, and to implement a wireless communication method comprising:
determining a precoding matrix from a codebook corresponding to a transmitted rank indicator TRI, wherein, each codeword in the codebook comprises 3 rows; and
transmitting the TRI and a transmit precoding matrix indicator (TPMI) corresponding to the precoding matrix to a terminal device, wherein, the TPMI is configured to be used by the terminal device to determine the precoding matrix from the codebook corresponding to the TRI.

17. The network device as claimed in claim 16, wherein
in response to the number of the transport layers indicated by the TRI being 1, the codebook comprises at least one of: a first vector, a second vector, a third vector, and a fourth vector; wherein the first vector is a constant-modulus 3-discrete Fourier transform (DFT) vector; three elements of the second vector are all constant-modulus quadrature phase shift keying (QPSK) elements; in the third vector, one element is 1, one element is a QPSK element and one element is 0; and in the fourth vector, one element is 1, other two elements are 0; and/or
in response to the number of the transport layers indicated by the TRI being 2, the codebook comprises at least one precoding matrix of: a first precoding matrix, a second precoding matrix, a third precoding matrix, a fourth precoding matrix and a fifth precoding matrix; wherein each column of the first precoding matrix is a constant-modulus DFT vector; each non-zero element of the second precoding matrix is a constant-modulus QPSK element; a first column of the third precoding matrix consists of constant-modulus QPSK elements, a second column of the third precoding matrix consists of constant-modulus non-QPSK elements, and a second column vector of the third precoding matrix is orthogonal to a first column vector of the third precoding matrix; a first column of the fourth precoding matrix comprises two QPSK elements, a second column of the fourth precoding matrix comprises one QPSK element, the three QPSK elements are in different rows, and the other elements are 0; each of two columns of the fifth precoding matrix comprises one element whose value is 1, the two elements are in different rows, and the other elements are all 0; and/or
in response to the number of the transport layers indicated by the TRI being 3, the codebook comprises an identity matrix of size 3.

18. The network device as claimed in claim 17, wherein
the first vector is at least one of the 3O vectors, the 3O vectors are obtained by performing O times of oversampling on the DFT vector with a length of 3; and/or
the first vector is at least one vector of the following vector set:
$$\begin{matrix}{W}_{m}^{( 1 )} = {\frac{1}{\sqrt{3}} [ \begin{matrix}1 & {e}^{j \frac{2 π m}{3 O}} & {e}^{j \frac{4 π m}{3 O}}\end{matrix} ]}^{T} \\ m = 0 , 1 , … 3 O - 1 ,\end{matrix}$$
wherein O is a positive integer.

19. The network device as claimed in claim 17, wherein
a first element of the second vector is 1; and/or
the second vector is at least one vector of the following vector set:
$$\frac{1}{\sqrt{3}} [ \begin{matrix}1 \\ 1 \\ j\end{matrix} ] , \frac{1}{\sqrt{3}} [ \begin{matrix}1 \\ 1 \\ - j\end{matrix} ] , \frac{1}{\sqrt{3}} [ \begin{matrix}1 \\ - 1 \\ j\end{matrix} ] , \frac{1}{\sqrt{3}} [ \begin{matrix}1 \\ - 1 \\ - j\end{matrix} ] , \frac{1}{\sqrt{3}} [ \begin{matrix}1 \\ j \\ 1\end{matrix} ] , \frac{1}{\sqrt{3}} [ \begin{matrix}1 \\ j \\ - 1\end{matrix} ] , \frac{1}{\sqrt{3}} [ \begin{matrix}1 \\ - j \\ 1\end{matrix} ] , \frac{1}{\sqrt{3}} [ \begin{matrix}1 \\ - j \\ - 1\end{matrix} ] .$$

20. The network device as claimed in claim 17, wherein
the third vector is at least one vector of the following vector set:
$$\frac{1}{\sqrt{3}} [ \begin{matrix}1 \\ 1 \\ 0\end{matrix} ] , \frac{1}{\sqrt{3}} [ \begin{matrix}1 \\ - 1 \\ 0\end{matrix} ] , \frac{1}{\sqrt{3}} [ \begin{matrix}1 \\ j \\ 0\end{matrix} ] , \frac{1}{\sqrt{3}} [ \begin{matrix}1 \\ - j \\ 0\end{matrix} ] , \frac{1}{\sqrt{3}} [ \begin{matrix}1 \\ 0 \\ 1\end{matrix} ] , \frac{1}{\sqrt{3}} [ \begin{matrix}1 \\ 0 \\ - 1\end{matrix} ] , \frac{1}{\sqrt{3}} [ \begin{matrix}1 \\ 0 \\ j\end{matrix} ] , \frac{1}{\sqrt{3}} [ \begin{matrix}1 \\ 0 \\ - j\end{matrix} ] ;$$
and/or
the fourth vector is at least one vector of the following vector set:
$$\frac{1}{\sqrt{3}} [ \begin{matrix}1 \\ 0 \\ 0\end{matrix} ] , \frac{1}{\sqrt{3}} [ \begin{matrix}0 \\ 1 \\ 0\end{matrix} ] , \frac{1}{\sqrt{3}} [ \begin{matrix}0 \\ 0 \\ 1\end{matrix} ] .$$
